(19) United States
(12) Patent Application Publication
(10) Pub. No.: US 2024/0256634 A1
(43) Pub. Date: Aug. 1, 2024

(54) DATA ANALYSIS DEVICE, DATA ANALYSIS METHOD, AND DATA ANALYSIS PROGRAM

(71) Applicant: ENJYN CORPORATION, Tokyo (JP)

(72) Inventor: Toshiaki Edamitsu, Tokyo (JP)

(21) Appl. No.: 18/293,136

(22) PCT Filed: Mar. 26, 2022
(86) PCT No.: PCT/JP2022/014749

§ 371 Date: Jan. 29, 2024

(30) Foreign Application Priority Data
Jul. 30, 2021 (JP) 2021-126294

(51) Int. Cl. G06F 17/18; G06F 17/16

(52) U.S. Cl. CPC G06F 17/18; G06F 17/16

(57) ABSTRACT

[PROBLEM TO BE SOLVED] Provided is a data analysis method which can transform a pi number data vector, which is numerical data of pi numbers, into a variable quantity data vector, which is numerical data of variable quantities, without adding a condition for closing equations between the variable quantities and the pi numbers.

[SOLUTIONS TO THE PROBLEMS] A pi number inverse transformation processing in a data analysis method inversely transforms the pi number data vector π, composed of pi number data that is numerical data of the pi numbers, into the variable quantity data vector (q), composed of variable quantity data that is numerical data of the variable quantities, based on pi number transformation information (P) which determines, by an exponent of variable quantities included in the pi numbers, a relationship between a variable quantity set composed of a plurality of the variable quantities observed in the predetermined phenomenon and a pi number set composed of one or a plurality of pi numbers configured to be transformed from the variable quantities. In the performing of the inverse transformation includes performing a numerical analysis in which a range of the numerical data in the variable quantity data vector (q) is set to a particular variable quantity region D, and performing pi number inverse transformation processing which inversely transforms the pi number data vector n into the variable quantity data vector (q) existing in the variable quantity region D.

### TECHNICAL FIELD

The present invention relates to a data analysis method, a data analysis device, and a data analysis program.

### BACKGROUND ART

Conventionally, it is known that numerical data can be handled with generalized scales without depending on a unit system or a scale by using pi numbers (also referred to as dimensionless quantities) that can be transformed from physical quantities in data analysis or simulation.

For example, Patent Document 1 discloses a simulation method for analyzing the behavior of a fluidized bed using physical property values and physical quantities after transformation of being transformed by predetermined transformation rules under a condition that dimensionless quantities do not change before and after coarse-graining to reduce the number of particles contained in the fluidized bed.

### PRIOR ART DOCUMENT

### Patent Document

Patent Document 1: WO 2019/181541

### SUMMARY OF INVENTION

### Problems to be Solved by Invention

In the simulation method disclosed in Patent Document 1, a fluidized bed before coarse-graining and a fluidized bed after coarse-graining satisfy similarity rules by predetermined transformation rules in which dimensionless quantities are constant before and after coarse-graining. At that time, before and after the transformation, an assumption is introduced that, for example, the apparent volume of the region filled with particles does not change, the particle temperature and the gas temperature do not change, and the sensible heat of all particles does not change, and then the physical property values and the physical quantities are transformed according to the transformation rules described above. By introducing such an assumption, the equation for obtaining the physical property value and the physical quantities after transformation is closed, and thus, the physical property value and the physical quantities after transformation are obtained as a particular solution that satisfies the similarity rules.

However, as described above, in a situation where an assumption that fixes a part of the physical quantities is not introduced or cannot be introduced, the equations are not closed, and thus, it has not been possible to uniquely obtain a particular solution that satisfies the similarity rules by transformation using pi numbers. This is because, when there are a plurality of variable quantities (for example, physical quantities) involved in a predetermined phenomenon, the phenomenon is caused by Buckingham's Pi Theorem (see Equation [Formula 7] described below) in which the phenomenon is expressed by the pi numbers (that is, the pi numbers having the number smaller than the number of variable quantities) having the number obtained by subtracting, from the number of the plurality of variable quantities, the number of basic units constituting the variable quantities thereof.

The present invention has been made in view of the above-described problems, and an object thereof is to provide a data analysis method, a data analysis device, and a data analysis program capable of transforming a pi number data vector, which is numerical data of pi numbers, into a variable quantity data vector, which is numerical data of variable quantities, without adding a condition for closing equations between the variable quantities and the pi numbers.

### Solutions to Problems

In order to achieve the above object, a data analysis method according to an aspect of the present invention is a data analysis method for analyzing data on a predetermined phenomenon using a computer, the data analysis method including performing an inverse transformation on a pi number data vector (π) to obtain a variable quantity data vector (q) based on pi number transformation information (P). The pi number transformation information (P) determines, by an exponent of variable quantities included in pi numbers, a relationship between a variable quantity set (Qv) composed of a plurality of the variable quantities observed in the phenomenon and a pi number set (Πv) composed of one or a plurality of pi numbers configured to be transformed from the variable quantities. The pi number data vector (π) is composed of pi number data that is numerical data of the pi numbers. The variable quantity data vector (q) is composed of variable quantity data that is numerical data of the variable quantities. The performing of the inverse transformation includes: performing a numerical analysis in which a range of the numerical data in the variable quantity data vector (q) is set to a particular variable quantity region (D), and performing pi number inverse transformation processing (S2) which inversely transforms the pi number data vector (π) into the variable quantity data vector (q) existing in the variable quantity region (D).

### Effects of Invention

According to the data analysis method according to one aspect of the present invention, by incorporating the numerical analysis in which the range of the numerical data in the variable quantity data vector has been set to the particular variable quantity region, the pi number data vector is transformed into the variable quantity data vector existing within the variable quantity region. Therefore, the pi number data vector can be transformed into the variable quantity data vector even without adding a condition for closing the equations between the variable quantities and the pi numbers.

Problems, configurations, and effects other than those described above will be clarified in a mode for carrying out the invention described below.

### BRIEF DESCRIPTION OF THE DRAWINGS

FIG. 1 is a configuration diagram showing an example of a data analysis device 1.

FIG. 2 is a schematic diagram showing respective pieces of processing S1 to S8 performed in the data analysis method 100.

FIG. 3 is a hardware configuration diagram showing an example of the computer 200.

FIG. 4 is a schematic diagram showing a physical phenomenon of a disk subjected to a uniformly-distributed load.

FIG. 5 is a schematic diagram showing the pi number transformation by the pi number transformation processing S1.

FIG. 6 is a schematic diagram showing the pi number indefinite inverse transformation by the pi number inverse transformation processing S2.

FIG. 7 is a schematic diagram showing the pi number transformation/indefinite inverse transformation by the pi number transformation/inverse transformation processing S3.

FIG. 8 is a flowchart showing an example of the phenomenon prediction processing S6.

FIG. 9 is a scatter diagram matrix showing a physical quantity data set A for training.

FIG. 10 is a diagram showing the regression model f created from the physical quantity data set A.

FIG. 11 is a scatter diagram matrix showing the explanatory variable data vector x of physical quantities of the physical quantity data set B transformed into the interpolation range of the regression model f by the pi number transformation/indefinite inverse transformation.

FIG. 12 is a scatter diagram matrix showing the physically similar explanatory variable data vector x′ of physical quantities of the physical quantity data set B transformed into the interpolation range of the regression model f by the pi number transformation/indefinite inverse transformation.

FIG. 13 is a diagram showing the result of performing the prediction of objective variables by the phenomenon prediction processing S6 on explanatory variables included in the physical quantity data set B.

FIG. 14 is a diagram showing the result at the time of performing the prediction of objective variables by the normal regression model f on explanatory variables included in the physical quantity data set B.

FIG. 15 is a diagram showing a comparison result obtained by comparing the dependency of the predictability rate R_{pred} on the range enlargement ratio R_{range} between the prediction by the phenomenon prediction processing S6 and the prediction by the normal regression model f.

FIG. 16 is a diagram showing a comparison result obtained by comparing the determination coefficients of the predicted value and the correct answer (true value) in the prediction by the phenomenon prediction processing S6 and the prediction by the normal regression model f.

FIG. 17 is a flowchart showing an example of the similarity transformation validity evaluation processing S71.

FIG. 18 is a first schematic diagram showing the self-space pi number transformation/indefinite inverse transformation by the self-space pi number transformation/inverse transformation processing S5.

FIG. 19 is a second schematic diagram showing the self-space pi number transformation/indefinite inverse transformation by the self-space pi number transformation/inverse transformation processing S5.

FIG. 20 is a diagram showing an example of a method of correcting the explanatory variable data vector of physical quantities.

FIG. 21 is a flowchart showing an example of the relational expression existence evaluation processing S72.

FIG. 22 is a flowchart showing an example of the pi number search processing S8.

### DETAILED DESCRIPTION

Hereinafter, embodiments for performing the present invention will be described with reference to the drawings. Hereinafter, a scope necessary for the description for achieving the object of the present invention will be schematically shown, a scope necessary for the description of the corresponding portion of the present invention will be mainly described, and a portion where the description is omitted will be based on a known technique.

### (1) Overview of Configuration of Data Analysis Device 1 and Respective Pieces of Processing S1 to S8 of Data Analysis Method 100

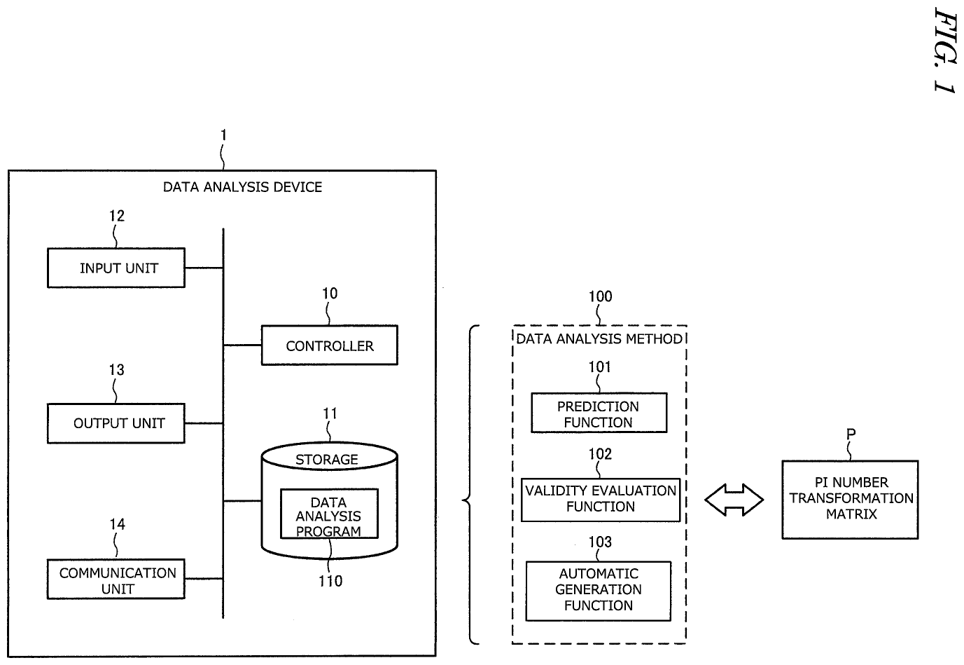

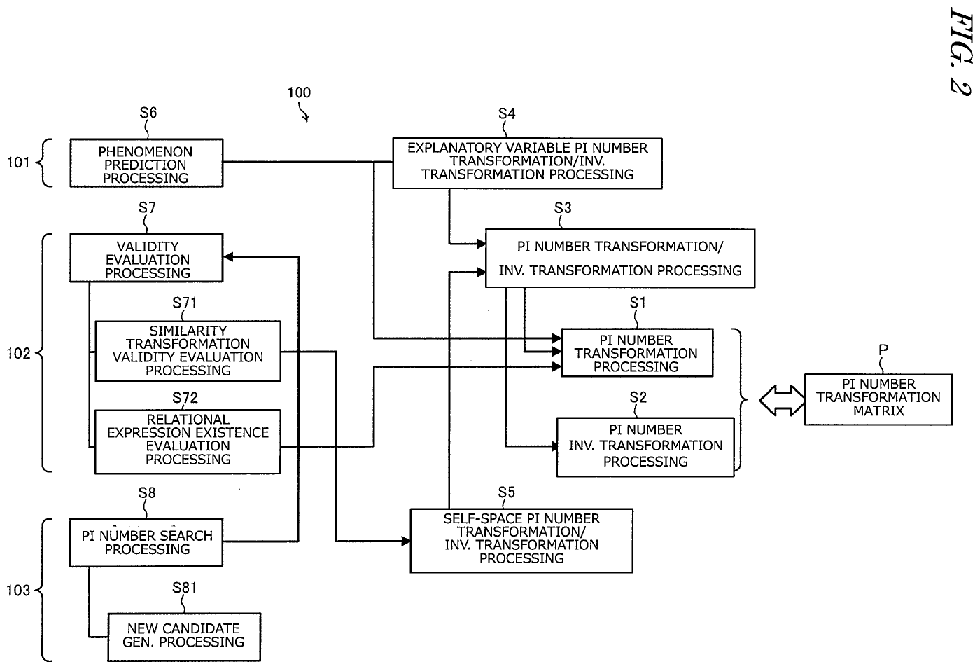

FIG. 1 is a configuration diagram showing an example of a data analysis device 1. FIG. 2 is a schematic diagram showing respective pieces of processing S1 to S8 performed in the data analysis method 100.

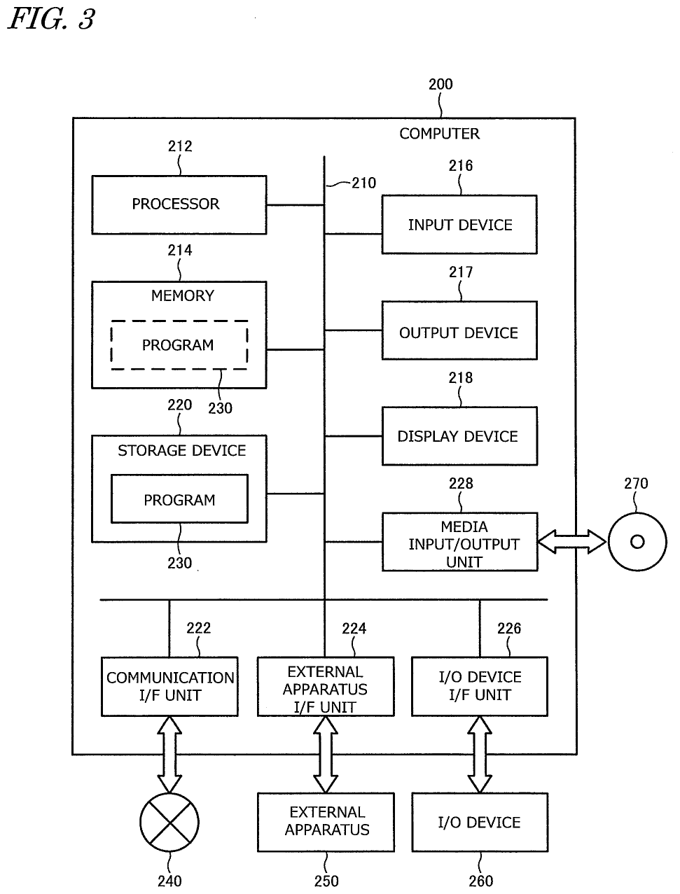

The data analysis device 1 is a device capable of executing the data analysis method 100 for analyzing data regarding a predetermined phenomenon, and includes, for example, a general-purpose or dedicated computer (see FIG. 3 described below).

In a predetermined phenomenon, a plurality of variable quantities that interact under a predetermined law (also including those referred to as rules) are observed, and the observed variable quantities are digitized and collected as numerical data, thereby generating a data set to be analyzed by the data analysis method 100. The predetermined law may be any law as long as a plurality of variable quantities are involved, and includes, for example, not only laws such as physical laws and mathematical laws but also laws such as economic laws, market laws, and psychological laws.

The data analysis device 1 includes a controller 10, a storage 11, an input unit 12, an output unit 13, and a communication unit 14 as main components thereof. The controller 10 functions as a data analysis unit by executing the data analysis program 110 stored in the storage 11, and executes respective pieces of processing S1 to S8 performed by the data analysis method 100. In addition to storing the data analysis program 110 and various types of data used in the data analysis program 110, the storage 11 stores, for example, an operating system (OS), other programs, data, and the like. The input unit 12 receives various input operations, and the output unit 13 outputs various types of information through a display screen or voice, thereby functioning as a user interface of each piece of processing S1 to S8. The communication unit 14 is connected to a wired or wireless network and transmits and receives various types of data to and from other devices (not shown).

In the data analysis method 100, when data regarding a predetermined phenomenon is analyzed, various types of processing S1 to S8 (details will be described below) are performed using the pi numbers corresponding to the phenomenon.

Specifically, various types of processing S1 to S8 are performed using a pi number transformation matrix P (details will be described below) that is a form of pi number transformation information that defines a relationship between variable quantities observed in a phenomenon to be processed and pi numbers that can be transformed from the variable quantities. The pi number transformation information is information that enables a transformation from variable quantities to pi numbers or an inverse transformation from a pi numbers to variable quantities while maintaining a similarity rules.

The various types of processing S1 to S8 included in the data analysis method 100 implement basic functions using the property of pi numbers, and are roughly divided into a prediction function 101 that predicts a predetermined phenomenon using pi numbers, a validity evaluation function 102 that evaluates validity of pi numbers, and an automatic generation function 103 that automatically generates pi numbers as the basic functions. It should be noted that, since the above-described basic functions are closely related, the data analysis method 100 preferably systematically performs various types of processing S1 to S8 for implementing the above-described basic functions, but may perform only some of the various types of processing S1 to S8 (may be used alone or in any combination). In that case, the data analysis device 1 is configured as a device that executes the some of the types of processing, and the data analysis program 110 is configured as a program that causes a computer (controller 10) to execute the some of the types of processing.

As processing common to the basic functions, the data analysis method 100 performs at least one of pi number transformation processing S1 and pi number inverse transformation processing S2. Any one of the pi number transformation processing S1 and the pi number inverse transformation processing S2 may be performed alone, or both may be performed in combination. The data analysis method 100 performs pi number transformation/inverse transformation processing S3, explanatory variable pi number transformation/inverse transformation processing S4 using the pi number transformation/inverse transformation processing S3, and self-space pi number transformation/inverse transformation processing S5, as processing performed in combination of the pi number transformation processing S1 and the pi number inverse transformation processing S2.

As processing of implementing the prediction function 101, the data analysis method 100 performs phenomenon prediction processing S6. In the process of the phenomenon prediction processing S6, pi number transformation processing S1 and pi number transformation/inverse transformation processing S3 are performed.

As processing of implementing the validity evaluation function 102, the data analysis method 100 performs pi number validity evaluation processing S7 including at least one of the similarity transformation validity evaluation processing S71 and the relational expression existence evaluation processing S72. In the similarity transformation validity evaluation processing S71, a self-space pi number transformation/inverse transformation processing S5 is performed in the process of the processing. In the relational expression existence evaluation processing S72, the pi number transformation processing S1 is performed in the process of the processing.

As processing of implementing the automatic generation function 103, the data analysis method 100 performs pi number search processing S8 including new candidate generation processing S81. In the process of the pi number search processing S8, pi number validity evaluation processing S7 is performed.

FIG. 3 is a hardware configuration diagram showing an example of the computer 200. The computer 200 is an example of a device constituting the data analysis device 1, and is configured as a general-purpose or dedicated computer.

As shown in FIG. 3, the computer 200 includes a bus 210, a processor 212, a memory 214, an input device 216, an output device 217, a display device 218, a storage device 220, a communication interface (I/F) unit 222, an external apparatus I/F unit 224, an input/output (I/O) device I/F unit 226, and a media input/output unit 228 as main components thereof. It should be noted that the above-described components may be appropriately omitted according to applications for which the computer 200 is used. The processor 212 includes one or a plurality of arithmetic processing units (a central processing unit (CPU), a micro-processing unit (MPU), a digital signal processor (DSP), a graphics processing unit (GPU), or the like), and operates as the controller 10 that controls the entire computer 200. The memory 214 stores various types of data and programs 230, and includes, for example, a volatile memory (DRAM, SRAM, or the like) that functions as a main memory, a nonvolatile memory (ROM), a flash memory, and the like.

The input device 216 includes, for example, a keyboard, a mouse, a numeric keypad, an electronic pen, and the like, and functions as the input unit 12. The output device 217 includes, for example, a sound (voice) output device, a vibration device, and the like, and functions as the output unit 13. The display device 218 includes, for example, a liquid crystal display, an organic EL display, electronic paper, a projector, and the like, and functions as the output unit 13. The input device 216 and the display device 218 may be integrally configured as with a touch panel display. The storage device 220 includes, for example, a hard disk drive (HDD), a solid state drive (SSD), or the like, and functions as the storage 11. The storage device 220 stores various types of data necessary for executing the operating system and the program 230.

The communication I/F unit 222 is connected to a network 240 such as the Internet or an intranet in a wired or wireless manner, and functions as a communication unit 14 that transmits and receives data to and from another computer according to a predetermined communication standard. The external apparatus I/F unit 224 is connected to an external apparatus 250 such as a camera, a printer, a scanner, and a reader/writer in a wired or wireless manner, and functions as a communication unit 14 that transmits and receives data to and from the external apparatus 250 according to a predetermined communication standard. The I/O device I/F unit 226 is connected to an I/O device 260 such as various sensors and actuators, and functions as a communication unit 14 that transmits and receives various signals and data such as a detection signal by a sensor and a control signal to an actuator, for example, to and from the I/O device 260. The media input/output unit 228 includes, for example, a drive device such as a digital versatile disc (DVD) drive or a compact disc (CD) drive, and reads/writes data from/to a medium (non-transitory storage medium) 270 such as a DVD or a CD.

In the computer 200 having the above configuration, the processor 212 calls and executes the program 230 stored in the storage device 220 in the memory 214, and controls each unit of the computer 200 through the bus 210. Note that the program 230 may be stored in the memory 214 instead of the storage device 220. The program 230 may be recorded in the medium 270 in an installable file format or an executable file format and provided to the computer 200 through the media input/output unit 228. The program 230 may be provided to the computer 200 by being downloaded via the network 240 through the communication I/F unit 222. In addition, the computer 200 may implement various functions, to be implemented by the processor 212 executing the program 230, by hardware such as a field-programmable gate array (FPGA) or an application specific integrated circuit (ASIC).

The computer 200 includes, for example, a desktop computer or a portable computer, and is an electronic apparatus in any form. In addition, the computer 200 may be a client computer, a server computer, or a cloud computer.

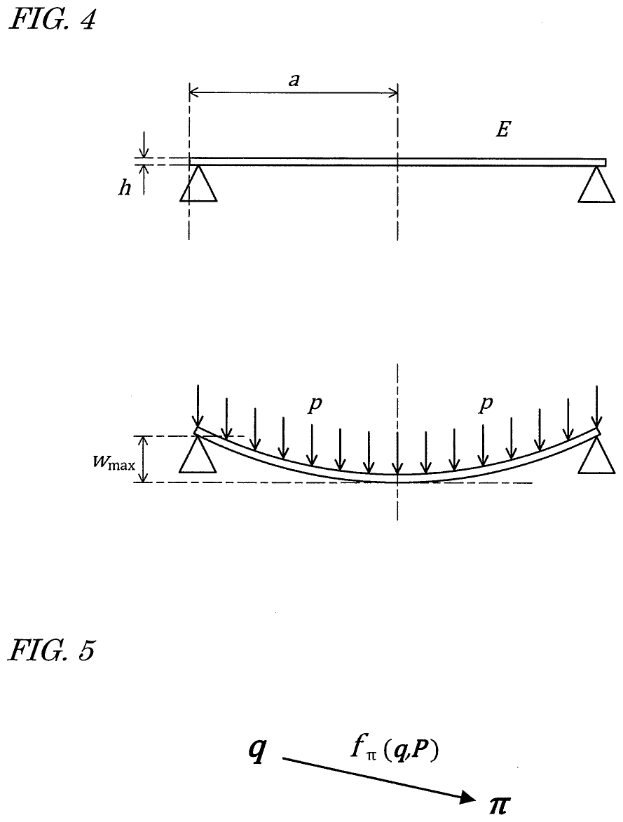

Next, details of each piece of processing S1 to S8 of the data analysis method 100 performed by the data analysis device 1 having the above configuration will be described with reference to FIGS. 4 to 22. In the present embodiment, as a predetermined phenomenon, a case where a plurality of physical quantities are observed as a plurality of variable quantities will be mainly described by taking a “physical phenomenon of a disk subjected to a uniformly-distributed load” shown in FIG. 4 to be described below as an example.

### (2) Physical Quantities, Pi Numbers, and a Pi Number Transformation Matrix P

FIG. 4 is a schematic diagram showing a physical phenomenon of a disk subjected to a uniformly-distributed load. The plurality of physical quantities qᵥ observed in the physical phenomenon of the disk shown in FIG. 4 are five of the maximum displacement wₘₐₓ of the disk, the uniformly-distributed load p subjected to the disk, the radius a of the disk, the plate thickness h of the disk, and the Young's modulus E of the disk. Let a set of physical quantities qᵥ including these five physical quantities qᵥ₁ to qᵥ₅ {qᵥ₁, qᵥ₂, qᵥ₃, qᵥ₄, qᵥ₅} be represented by a “physical quantity set Qv” as expressed in the following [Formula 1] equation.

$$Physical quantity set : {Q}_{v} = \{ {q}_{v 1} , {q}_{v 2} , {q}_{v 3} , {q}_{v 4} , {q}_{v 5} \} = \{ {w}_{max} , p , a , h , E \} \qquad [ Formula 1 ]$$

As the prediction function in the physical phenomenon of the disk, for example, when the maximum displacement wₘₐₓ, which is one of the physical quantities, is predicted, the physical quantities wₘₐₓ is referred to as an “objective variable”, and other physical quantities p, a, h, and E other than the physical quantities wₘₐₓ are referred to as “explanatory variables”. In the present embodiment, the description will be given on the assumption that the objective variable (maximum displacement wₘₐₓ) is arranged in the first element qᵥ₁ of the physical quantity set Qv.

As a theoretical equation in a physical phenomenon of a disk, when large deflection (nonlinear region) is considered, it is known that the maximum displacement wₘₐₓ follows a governing equation expressed by the following [Formula 2] equation.

$$\frac{{w}_{max}}{h} + {A ( \frac{{w}_{max}}{h} )}^{3} = B \frac{p}{E} {( \frac{a}{h} )}^{4} \qquad [ Formula 2 ]$$

In [Formula 2] equation, A and B are constants determined by a boundary condition. For example, when the boundary condition for deflection is simple support and displacement in the radial direction is free, A=0.262 and B=0.696 are obtained. In addition, the first term on the left side is a linear term that is dominant at the time of minute transformation, and the second term is a nonlinear term that cannot be ignored at the time of large transformation.

In a physical phenomenon of a disk, a relationship between physical quantities qᵥ₁ to qᵥ₅ and exponents (dimensions) of basic units of the respective physical quantities qᵥ₁ to qᵥ₅ is expressed by the following [Table 1]. The basic units of the physical quantities qᵥ₁ to qᵥ₅ are N (Newton) and m (meter), and the objective variable (maximum displacement wₘₐₓ) is described as being arranged in the first column (the leftmost column of the numerical value portion) of [Table 1].

TABLE 1

| | wₘₐₓ | p | a | h | E |
|---|---|---|---|---|---|
| N | 0 | 1 | 0 | 0 | 1 |
| m | 1 | −2 | 1 | 1 | −2 |

Only the numerical value portion in [Table 1] is extracted and expressed in the form of a matrix as shown in the following [Formula 3] equation, which is referred to as a “dimensional matrix D”.

$$D = ( \begin{matrix}0 & 1 & 0 & 0 & 1 \\ 1 & - 2 & 1 & 1 & - 2\end{matrix} ) \qquad [ Formula 3 ]$$

Here, based on the Buckingham's Pi theorem, three pi numbers πᵥ₁ to πᵥ₃ are obtained as shown in the following [Formula 4] equation by performing dimensional analysis on the dimensional matrix D shown in [Formula 3] equation. Let a set {πᵥ₁, πᵥ₂, πᵥ₃} of the pi numbers πᵥ including the three pi numbers πᵥ₁ to πᵥ₃ be represented by “pi number set Πv”.

$$Pi number set : {\prod }_{v} = \{ {π}_{v 1} , {π}_{v 2} , {π}_{v 3} \} = \{ \frac{{w}_{max}}{h} , \frac{p}{E} , \frac{a}{h} \} \qquad [ Formula 4 ]$$

The Buckingham's Pi theorem ensures that in the phenomenon governed by the governing equation, the relational expression F of the pi numbers πᵥ exists. That is, when the number of pi numbers πᵥ is k, there exists a relational expression F satisfying the following [Formula 5] equation.

$$F ( {π}_{v 1} , {π}_{v 2} , … , {π}_{vk} ) = 0 \qquad [ Formula 5 ]$$

In the physical phenomenon of the disk, when three pi numbers {πᵥ₁, πᵥ₂, πᵥ₃} shown in [Formula 4] equation are substituted into [Formula 2] equation, the following [Formula 6] equation is obtained. [Formula 6] equation corresponds to [Formula 5] equation ensured by the Buckingham's Pi theorem.

$${π}_{v 1} = A {{π}_{v 1}}^{3} = B {π}_{v 2} {{π}_{v 3}}^{4} \qquad [ Formula 6 ]$$

In addition, the number k of pi numbers is obtained by the following [Formula 7] equation from the number n of physical quantities and the number rankD of dimensions of the dimensional matrix D according to the Buckingham's Pi theorem.

k=n−rank D [Formula 7]

In the physical phenomenon of the disk, since the number k=3 of the pi numbers πᵥ is calculated with n=5 and rankD=2 in [Formula 7] equation, the calculated number matches the number (three) of the pi numbers πᵥ included in the pi number set Πv shown in [Formula 4] equation.

As described above, the relationship between the physical quantity set Qv including the plurality of physical quantities qᵥ observed in the physical phenomenon and the pi number set Πv including one or a plurality of pi numbers πᵥ that can be transformed from the physical quantities is expressed in the following [Table 2] as the pi number transformation information.

TABLE 2

| | wₘₐₓ | p | a | h | E |
|---|---|---|---|---|---|
| πᵥ₁ | 1 | 0 | 0 | −1 | 0 |
| πᵥ₂ | 0 | 1 | 0 | 0 | −1 |
| πᵥ₃ | 0 | 0 | 1 | −1 | 0 |

Only the numerical value portion in [Table 2] in which the pi number transformation information is represented in a tabular format is extracted and represented in a matrix format as shown in the following [Formula 8] equation, which is referred to as a “pi number transformation matrix P”. In the present embodiment, the description will be given by adopting the “pi number transformation matrix P” as the format of the pi number transformation information. However, the pi number transformation information may be expressed in an any format other than a tabular format or a matrix format as long as the pi number transformation information includes information equivalent to the information expressed by [Table 2] or [Formula 8] equation.

$$P = ( \begin{matrix}1 & 0 & 0 & - 1 & 0 \\ 0 & 1 & 0 & 0 & - 1 \\ 0 & 0 & 1 & - 1 & 0\end{matrix} ) = ( \begin{matrix}{p}_{1} \\ {p}_{2} \\ {p}_{3}\end{matrix} ) \qquad [ Formula 8 ]$$

The pi number transformation matrix P determines the relationship between the physical quantity set Qv and the pi number set Πv by exponents of the physical quantities qᵥ included in the pi numbers πᵥ. The i-th row of the pi number transformation matrix P is referred to as a “pi number transformation vector pi”. It should be noted that the form of the pi number set Πv is not limited to one. This is because the number of basic units is smaller than the number of physical quantities, and when obtaining the pi numbers πᵥ by dimensional analysis, only the same number of constraint expressions as the number of basic units exist. For example, the pi number set Πv expressed by [Formula 4] equation can be transformed into the following [Formula 9] equation or the like.

$$\{ \frac{{w}_{max}}{h} , \frac{p}{E} , \frac{a}{h} \} = \{ \frac{{w}_{max}}{a} , \frac{p}{E} , \frac{a}{h} \} = \{ \frac{{w}_{max}}{a} , \frac{E}{p} , \frac{{w}_{max}}{h} \} = \{ \frac{{w}_{max}}{a} , {( \frac{E}{p} )}^{2} , \frac{{w}_{max}}{h} \} \qquad [ Formula 9 ]$$

The transformation expressed by [Formula 9] equation corresponds to application of the row elementary transformation in the pi number transformation matrix P. By such a transformation, the explanatory variable can be necessarily transformed into a form only included in one pi number πᵥ, which corresponds to an operation of creating a staircase matrix by a row elementary transformation after placing the objective variable in the left end column in the pi number transformation matrix P. In the present embodiment, the description will be given assuming that the particular pi number (πᵥ₁) including the objective variable (Wₘₐₓ) is arranged only in the first row of [Table 2], and in the pi number transformation matrix P, the particular pi number (πᵥ₁) is arranged only in the pi number transformation vector p₁ in the first row of [Formula 8] equation.

Here, as described above, let the pi numbers πᵥ and the pi number set Πv obtained by the dimensional analysis be referred to as “mathematical pi numbers πₘ” and a “mathematical pi number set Πₘ”, respectively, and let a subscript m be added thereto.

In addition, there is a case where “physical pi numbers πₚ” in which the number of pi numbers is smaller than that of “mathematical pi numbers πₘ” can be derived by utilizing a governing equation that governs a physical phenomenon and knowledge related to a physical law.

For example, in the physical phenomenon of the disk, although [Formula 2] equation corresponds to the governing equation, since [Formula 2] equation already takes the form of the solution of the differential equation, it is recognized that three mathematical pi numbers (Πₘ={πᵥ₁, πᵥ₂, πᵥ₃}) shown in [Formula 4] equation exist in [Formula 2] equation. Furthermore, it is recognized that there is a possibility that a new pi numbers can be derived by integrating two mathematical pi numbers included on the right side of [Formula 2] equation into one. Therefore, based on the recognition as described above, two physical pi numbers {πₚ₁, πₚ₂} are obtained as shown in the following [Formula 10] equation. Let a set {πₚ₁, πₚ₂} of physical pi numbers πₚ including these two physical pi numbers {πₚ₁, πₚ₂} be represented by a “physical pi number set Πₚ”.

$${\prod }_{p} = \{ {π}_{p 1} , {π}_{p 2} \} = \{ \frac{{w}_{max}}{h} , \frac{{pa}^{4}}{{Eh}^{4}} \} \qquad [ Formula 10 ]$$

The relational expression F of the physical pi numbers πₚ is expressed by the following [Formula 11] equation. It should be noted that the relational expression F of the mathematical pi numbers πₘ is expressed by [Formula 6] equation.

$${π}_{p 1} + A {π}_{p 1}^{3} = B {π}_{p 2} \qquad [ Formula 11 ]$$

In order to derive the relational expression F of the physical pi numbers πₚ, that is, [Formula 11] equation, human physical knowledge is utilized. It can be interpreted that more condensed pi numbers are obtained by the effect. However, there is also a case where the number of pi numbers does not decrease even when human knowledge is utilized, and in that case, the mathematical pi numbers πₘ (πᵥ) and the physical pi numbers πₚ coincide with each other.

Furthermore, by approximating the physical phenomenon to a particular situation, an “approximate pi number πₐ” may be derived.

For example, assuming a case where only a phenomenon that can be regarded as large transformation (nonlinear region) is targeted in the physical phenomenon of the disk, the following [Formula 12] equation is obtained by erasing the linear term (first term on the left side) of [Formula 2] equation.

$${A ( \frac{{w}_{max}}{h} )}^{3} = B \frac{p}{E} {( \frac{a}{h} )}^{4} ∴ \frac{{w}_{max}^{3} Eh}{p {a}^{4}} = \frac{B}{A} \qquad [ Formula 12 ]$$

At this time, the left side of [Formula 12] equation represents a pi number, and one approximate pi number πₐ₁ is obtained as shown in the following [Formula 13] equation. Let a set {πₐ₁} of approximate pi numbers be represented by an “approximate pi number set Πₐ”.

$${Π}_{a} = \{ {π}_{a 1} \} = ( \frac{{w}_{max}^{3} Eh}{p {a}^{4}} ) \qquad [ Formula 13 ]$$

The relational expression F of the approximate pi numbers πₐ is expressed by the following [Formula 14] equation.

$${π}_{a 1} = \frac{B}{A} = const . \qquad [ Formula 14 ]$$

When the number of pi numbers is one, if one set of physical quantity data is provided, the pi number is determined as a constant as shown in [Formula 14] equation. That is, the pi number is not a variable but a constant value in all similar phenomena.

### (3) Definition of Data Structure

The definition of the data structure regarding the data handled in each piece of processing S1 to S8 will be described.

Numerical data obtained by substituting respective numerical values representing particular physical phenomena (conditions) into a physical quantity set Qv including a plurality of (n) physical quantities qv is defined as shown in the following [Formula 15] equation. Specifically, a vector having elements {q₁, q₂, . . . , qₙ} obtained by substituting respective pieces of numerical data into the physical quantity set Qv including a plurality of physical quantities qᵥ is defined as a “physical quantity data vector q”. Therefore, the physical quantity data vector q is data corresponding to the physical quantity set Qv and includes “physical quantity data” which is numerical data of the physical quantities qᵥ. As a set of a plurality of physical quantity data vectors q, a two-dimensional array in which a plurality of physical quantity data vectors q are vertically arranged is defined as a “physical quantity data set Q”.

In addition, when the plurality of physical quantities qᵥ are classified into the objective variable and the explanatory variable set including one or a plurality of explanatory variables, the physical quantity data vector q includes a set of pieces of “objective variable data y of physical quantities” that is numerical data of the objective variables and “explanatory variable data vector x of physical quantities” including explanatory variable data that is numerical data of the explanatory variables. As a set of pieces of the objective variable data y of physical quantities, a one-dimensional array in which a plurality of pieces of objective variable data y of physical quantities are vertically arranged is defined as a “objective variable data set Y of physical quantities”. As a set of explanatory variable data vectors x of physical quantities, a two-dimensional array in which a plurality of explanatory variable data vectors x of physical quantities are vertically arranged is defined as an “explanatory variable data set X of physical quantities”.

$$Physical quantity data vector : q = ( {q}_{1} , {q}_{2} , ⋯ , {q}_{n} ) = ( y , {x}_{1} , ⋯ , {x}_{n - 1} ) = ( y , x ) \\ Objective variable data of physical quantities : y \\ Explanatory variable data vector of physical quantities : x = ( {x}_{1} , ⋯ , {x}_{n - 1} ) \qquad [ Formula 15 ]$$

$$\begin{matrix}Physical quantity data set : Q = ( \begin{matrix}{q}_{1} \\ {q}_{2} \\ ⋮ \\ {q}_{s}\end{matrix} ) = ( \begin{matrix}{q}_{1 , 1} & {q}_{1 , 2} & ⋯ & {q}_{1 , n} \\ {q}_{2 , 1} & {q}_{2 , 2} & ⋯ & {q}_{2 , n} \\ ⋮ & ⋮ & & ⋮ \\ {q}_{s , 1} & {q}_{s , 2} & ⋯ & {q}_{s , n}\end{matrix} ) \\ = ( \begin{matrix}{y}_{1} & {x}_{1 , 1} & ⋯ & {x}_{1 , n - 1} \\ {y}_{2} & {x}_{2 , 1} & ⋯ & {x}_{2 , n - 1} \\ ⋮ & ⋮ & & ⋮ \\ {y}_{s} & {x}_{s , 1} & ⋯ & {x}_{s , n - 1}\end{matrix} ) = ( \begin{matrix}{y}_{1} & {x}_{1} \\ {y}_{2} & {x}_{2} \\ ⋮ & ⋮ \\ {y}_{s} & {x}_{s}\end{matrix} ) = ( Y , X )\end{matrix}$$

$${Objective variable data set of physical quantities}_{} : Y = ( \begin{matrix}{y}_{1} \\ {y}_{2} \\ ⋮ \\ {y}_{s}\end{matrix} ) \\ Explanatory variable data set of physical quantities : X = ( \begin{matrix}{x}_{1} \\ {x}_{2} \\ ⋮ \\ {x}_{s}\end{matrix} )$$

Similarly to the physical quantities qᵥ, numerical data obtained by substituting respective numerical values representing particular physical phenomena (conditions) also into a pi number set Πv including a plurality of (k) pi numbers πᵥ is defined as shown in the following [Formula 16] equation. Specifically, a vector having elements {π₁, π₂, . . . , πₖ} obtained by substituting respective pieces of numerical data into the pi number set Πv including a plurality of pi numbers πᵥ is defined as a “pi number data vector π”. Therefore, the pi number data vector π is data corresponding to the pi number set Πv, and includes “pi number data” which is numerical data of the pi numbers πᵥ. As a set of a plurality of pi number data vectors π, a two-dimensional array in which a plurality of pi number data vectors π are vertically arranged is defined as a “pi number data set Π”.

In addition, when the plurality of pi numbers πᵥ are classified into the objective variable and the explanatory variable set including one or a plurality of explanatory variables, the pi number data vector π includes a set of pieces of “objective variable data η of pi numbers” that is numerical data of the objective variables and “explanatory variable data vector ξ of pi numbers” including explanatory variable data that is numerical data of the explanatory variables. As a set of pieces of objective variable data η of pi numbers, a one-dimensional array in which a plurality of pieces of objective variable data η of pi numbers are vertically arranged is defined as a “objective variable data set H of pi numbers”. As a set of explanatory variable data vectors ξ of pi numbers, a two-dimensional array in which a plurality of explanatory variable data vectors ξ of pi numbers are vertically arranged is defined as a “explanatory variable data set Ξ of pi numbers”.

$$Pi number data vector : π = ( {π}_{1} , {π}_{1} , ⋯ , {π}_{k} ) = ( η , {ξ}_{1} , ⋯ , {ξ}_{k - 1} ) = ( η , ξ ) \\ Objective variable data of pi numbers : η \\ Explanatory variable data vector of pi numbers : ξ = ( {ξ}_{1} , ⋯ , {ξ}_{k - 1} ) \qquad [ Formula 16 ]$$

$$\begin{matrix}Pi number data set : Π = ( \begin{matrix}{π}_{1} \\ {π}_{2} \\ ⋮ \\ {π}_{s}\end{matrix} ) = ( \begin{matrix}{π}_{1 , 1} & {π}_{1 , 2} & ⋯ & {π}_{1 , k} \\ {π}_{2 , 1} & {π}_{2 , 2} & ⋯ & {π}_{2 , k} \\ ⋮ & ⋮ & & ⋮ \\ {π}_{s , 1} & {π}_{s , 2} & ⋯ & {π}_{s , k}\end{matrix} ) \\ = ( \begin{matrix}{η}_{1} & {ξ}_{1 , 1} & ⋯ & {ξ}_{1 , k - 1} \\ {η}_{2} & {ξ}_{2 , 1} & ⋯ & {ξ}_{2 , k - 1} \\ ⋮ & ⋮ & & ⋮ \\ {η}_{s} & {ξ}_{s , 1} & ⋯ & {ξ}_{s , k - 1}\end{matrix} ) = ( \begin{matrix}{η}_{1} & {ξ}_{1} \\ {η}_{2} & {ξ}_{2} \\ ⋮ & ⋮ \\ {η}_{s} & {ξ}_{s}\end{matrix} ) = ( H , Ξ )\end{matrix}$$

$$Objective variable data set of pi numbers : H = ( \begin{matrix}{η}_{1} \\ {η}_{2} \\ ⋮ \\ {η}_{s}\end{matrix} ) \\ Explanatory variable data set of pi numbers : Ξ = ( \begin{matrix}{ξ}_{1} \\ {ξ}_{2} \\ ⋮ \\ {ξ}_{s}\end{matrix} )$$

A pi number transformation matrix P for n physical quantities qᵥ and k pi numbers πᵥ is defined as shown in the following [Formula 17] equation. In addition, the i-th row of the pi number transformation matrix P is defined as a “pi number transformation vector pᵢ”.

$$Pi number transformation matrix : P = \qquad [ Formula 17 ]$$

$$( \begin{matrix}{p}_{1} \\ {p}_{2} \\ ⋮ \\ {p}_{k}\end{matrix} ) = ( \begin{matrix}{p}_{1 , 1} & {p}_{1 , 2} & ⋯ & {p}_{1 , n} \\ {p}_{2 , 1} & {p}_{2 , 2} & ⋯ & {p}_{2 , n} \\ ⋮ & ⋮ & & ⋮ \\ {p}_{k , 1} & {p}_{k , 2} & ⋯ & {p}_{k , n}\end{matrix} ) \\ Pi number transformation vector : {p}_{i} = ( {p}_{i , 1} , ⋯ , {p}_{i , n} )$$

### (4) Pi Number Transformation Processing S1

FIG. 5 is a schematic diagram showing the pi number transformation by the pi number transformation processing S1. The pi number transformation processing S1 is processing of transforming the physical quantity data vector q into the pi number data vector π based on the pi number transformation matrix P. Let the pi number transformation by the pi number transformation processing S1 be expressed by the following [Formula 18] equation.

$$π = {f}_{π} ( q , P ) \qquad [ Formula 18 ]$$

The pi number data vector π is uniquely transformed by substituting each value of the physical quantity data constituting the physical quantity data vector q into a corresponding definition formula of the pi number data constituting the pi number data vector π. For example, by substituting each value of five pieces of physical quantity data into the [Formula 4] equation indicating the definition formula of the pi number data, all pieces of pi number data are uniquely determined and are transformed into pi number data vectors π.

In addition, let processing in which the pi number transformation processing S1 transforms each of the physical quantity data vectors q included in the physical quantity data set Q into a corresponding pi number data vector π based on the pi number transformation matrix P be expressed by the following [Formula 19] equation.

$$Π = {f}_{π} ( Q , P ) \qquad [ Formula 19 ]$$

### (5) Pi Number Inverse Transformation Processing S2

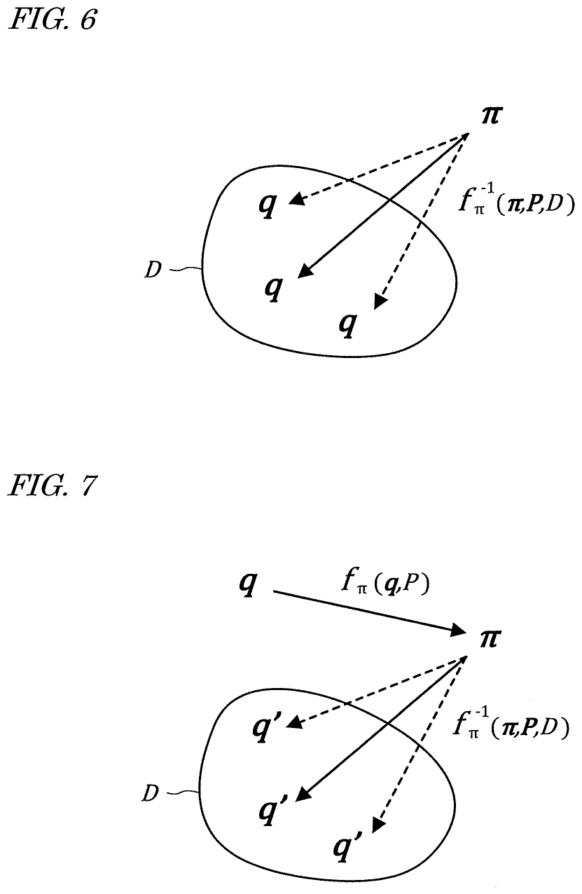

FIG. 6 is a schematic diagram showing the pi number indefinite inverse transformation by the pi number inverse transformation processing S2. The pi number inverse transformation processing S2 is processing of transforming the pi number data vector π into the physical quantity data vector q based on the pi number transformation matrix P. According to Buckingham's Pi theorem, since the number k of the pi numbers πᵥ is smaller than the number n of the physical quantities qᵥ, the equations are not closed between the pi number data vector π and the physical quantity data vector q when the pi number inverse transformation processing S2 is performed. Therefore, the pi number data vector π is not uniquely determined and has innumerable solutions. For example, in [Formula 4] equation, when each value of three pieces of pi number data is fixed to a constant, three equations are created. However, since the number n of the physical quantities qᵥ included in these equations is five, the physical quantity data is not uniquely determined.

Therefore, in the pi number inverse transformation processing S2, inverse transformation is performed into the physical quantity data vector q existing within the physical quantity region D by numerical analysis in which the range of the numerical data in the physical quantity data vector q is set to the particular physical quantity region D. As a method of numerical analysis, any algorithm that numerically searches for a solution of equations existing within a particular physical quantity region D can be applied, and for example, a Newton-Raphson method, a quasi newton method, or the like is applied. When the solution of the equation exists within the physical quantity region D, since the solution accidentally converges to one solution, an inverse transformation is performed into the physical quantity data vector q. As described above, in the pi number inverse transformation processing S2, let the transformation by the numerical analysis of the pi number data vector π into the physical quantity data vector q existing within the particular physical quantity region D based on the pi number transformation matrix P be referred to as “pi number indefinite inverse transformation”, and let the pi number indefinite inverse transformation by the pi number inverse transformation processing S2 be expressed by the following [Formula 20] equation.

$$q = {f}_{π}^{- 1} ( π , P , D ) \qquad [ Formula 20 ]$$

In addition, let processing in which the pi number inverse transformation processing S2 inversely transforms each of the pi number data vectors π included in the pi number data set II into a corresponding physical quantity data vector q based on the pi number transformation matrix P be expressed by the following [Formula 21] equation.

$$Q = {f}_{π}^{- 1} ( Π , P , D ) \qquad [ Formula 21 ]$$

As described above, according to the pi number inverse transformation processing S2, by incorporating the numerical analysis in which the range of the numerical data in the physical quantity data vector q has been set to the particular physical quantity region D, the pi number data vector π is transformed into the physical quantity data vector q existing within the physical quantity region D. Therefore, the pi number data vector π can be transformed into the physical quantity data vector q even without adding a condition for closing the equations between the physical quantities and the pi numbers.

### (6) Pi Number Transformation/Inverse Transformation Processing S3

FIG. 7 is a schematic diagram showing the pi number transformation/indefinite inverse transformation by the pi number transformation/inverse transformation processing S3. As shown in FIG. 7, the pi number transformation/inverse transformation processing S3 is processing of obtaining a physical quantity data vector q′ which is similar in satisfying the similarity rules (in the present embodiment, referred to as “physically similar”) to the physical quantity data vector q by performing the pi number transformation processing S1 and the pi number inverse transformation processing S2.

The pi number transformation processing S1 transforms the physical quantity data vector q into the pi number data vector π, and furthermore, the pi number inverse transformation processing S2 inversely transforms the pi number data vector π after transformation transformed by the pi number transformation processing S1 into the physical quantity data vector q′ existing within the particular physical quantity region D, whereby a physical quantity data vector q′ physically similar to the physical quantity data vector q is obtained. Since the physical quantity data vector q′ obtained by the pi number transformation/inverse transformation processing S3 is a solution that has accidentally converged from innumerable solutions, the physical quantity data vector q′ is different from the physical quantity data vector q before the transformation. However, since the physical quantity data vector q′ has the same pi number data vector π, it can be said that the physical quantity data vector q′ has a physically similar relationship with the physical quantity data vector q before the transformation.

As described above, the pi number transformation/inverse transformation processing S3 transforms the physical quantity data vector q into a physically similar physical quantity data vector q′ based on the pi number transformation matrix P. Let such transformation be referred to as “pi number transformation/indefinite inverse transformation”, and let the pi number transformation/indefinite inverse transformation by the pi number transformation/inverse transformation processing S3 be expressed by the following [Formula 22] equation.

$${q}^{′} = {f}_{π}^{- 1} ( {f}_{π} ( q , P ) , P , D ) = {f}_{π}^{- 1} ∘ {f}_{π} ( q , P , D ) \qquad [ Formula 22 ]$$

It should be noted that the particular physical quantity region D in the pi number inverse transformation processing S2 and the pi number transformation/inverse transformation processing S3 may be, for example, a region designated by a data analyst or a region derived from a data set to be analyzed. For example, as in the explanatory variable pi number transformation/inverse transformation processing S4 and the self-space pi number transformation/inverse transformation processing S5 described below, the particular physical quantity region D may be an interpolation range of the physical quantity data set Q, or a range narrower than the interpolation range. In addition, the target data (corresponding to the variable quantity data vector (q)) in the pi number transformation processing S1, the pi number inverse transformation processing S2, and the pi number transformation/inverse transformation processing S3 may be a part of the physical quantity data vector q instead of the physical quantity data vector q. For example, the target data may be the explanatory variable data vector x of physical quantities constituting the physical quantity data vector q or a part of the explanatory variable data vector x of physical quantities.

As described above, according to the pi number transformation/inverse transformation processing S3, by incorporating the numerical analysis in which the range of the numerical data in the physical quantity data vector q has been set in the particular physical quantity region D, the physical quantity data vector q is transformed into the physical quantity data vector q′ existing in the physical quantity region D. Therefore, it is possible to obtain the physical quantity data vector q′ that is physically similar to the physical quantity data vector q even without adding a condition for closing the equations between the physical quantities and the pi numbers.

### (7-1) Phenomenon Prediction Processing S6

Although a theoretical formula (for example, in a physical phenomenon of a disk, a governing equation expressed by [Formula 2] equation) established in a predetermined phenomenon is unknown, in a situation where the physical quantity data set Q observed in the phenomenon and the pi numbers representing the phenomenon (specifically, the pi number transformation matrix P_{pred} to be processed) are obtained, the phenomenon prediction processing S6 is processing of predicting an unknown objective variable (objective variable data yₒᵤₜ of physical quantities) with respect to the explanatory variable (explanatory variable data vector xₒᵤₜ of physical quantities) to be predicted using the pi numbers. At that time, the explanatory variable to be predicted may exist in the interpolation range of the physical quantity data set Q or may exist in the extrapolation range of the physical quantity data set Q.

The pi numbers used in the phenomenon prediction processing S6, that is, the pi number transformation matrix P_{pred} to be processed may be any one of mathematical pi numbers, physical pi numbers, and approximate pi numbers, or may be any pi numbers other than these. In addition, the pi number transformation matrix P_{pred} to be processed may be generated using an automatic generation function implemented in the pi number search processing S8 described below or may be generated based on the knowledge of a data analyst.

In the phenomenon prediction processing S6, by performing the pi number transformation/inverse transformation processing S3 on the explanatory variable (explanatory variable data vector xₒᵤₜ of physical quantities) to be predicted existing in the interpolation range or the extrapolation range of the physical quantity data set Q, the physically similar explanatory variable (explanatory variable data vector x′ₒᵤₜ of physical quantities) is numerically found in the interpolation range of the physical quantity data set Q. When a physically similar explanatory variable is found, a predicted value of the objective variable (objective variable data y′ₒᵤₜ of physical quantities by model prediction) is obtained from the physically similar explanatory variable by using a prediction model created from the physical quantity data set Q, and further, based on the pi number data vector (πₒᵤₜ) after transformation transformed by performing the pi number transformation processing S1 on the predicted value of the objective variable, conversion is performed into an unknown objective variable (objective variable data yₒᵤₜ of physical quantities). Accordingly, even when the explanatory variable to be predicted exists in the extrapolation range of the physical quantity data set Q, the phenomenon prediction processing S6 implements the prediction of the extrapolation with accuracy close to the prediction of the interpolation.

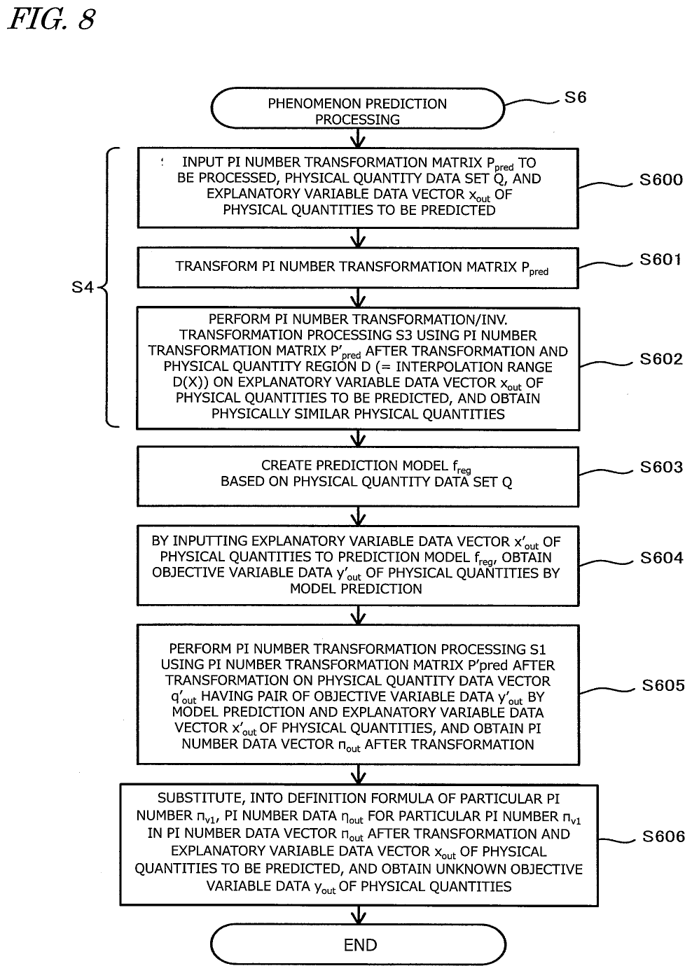

FIG. 8 is a flowchart showing an example of the phenomenon prediction processing S6.

First, in step S600, the pi number transformation matrix P_{pred} to be processed is input, and the physical quantity data set Q and the explanatory variable data vector xₒᵤₜ of physical quantities to be predicted are input. It should be noted that these pieces of data may be read from the storage 11, may be input through the input unit 12, or may be received from another device connected to the network.

The physical quantity data set Q input in step S600 is a set of physical quantity data vectors q having the objective variable data y of physical quantities and the explanatory variable data vector x of physical quantities as a pair, as shown in [Formula 15] equation. In addition, as preprocessing for suppressing deterioration in the accuracy of numerical analysis in the pi number transformation/indefinite inverse transformation described below, the digits of each piece of numerical data included in the physical quantity data set Q may be corrected as necessary.

Next, in step S601, by transforming the pi number transformation matrix P_{pred} to be processed so that the exponents of the objective variable included in the pi number π^{v} are 0 except for the particular pi number πᵥ₁, the pi number transformation matrix P′_{pred} after the transformation is created. In the present embodiment, a description will be given assuming that the particular pi number πᵥ₁ including the objective variable is transformed to be arranged only in the first row, for example, as shown in [Table 2]. That is, as shown in [Formula 8], transformation is performed so that the first element is an integer other than 0 in the pi number transformation vector p₁ in the first row, and the first element is 0 in the other pi number transformation vectors p₂ and p₃.

It should be noted that step S601 may be performed as preprocessing before the pi number transformation matrix P_{pred} to be processed is input in step S600 or step S601 may be omitted when the pi number transformation matrix P_{pred} to be processed originally has a form after the transformation. In that case, in each step in and after step S602, the pi number transformation matrix P_{pred} to be processed input in step S600 only needs to be regarded as the pi number transformation matrix P′_{pred} after the transformation and executed.

Next, as shown in the following [Formula 23] equation, in step S602, with an interpolation range D(X) of the explanatory variable data set X of physical quantities which is a set of the explanatory variable data vectors x of physical quantities included in the physical quantity data set Q as the physical quantity region D, by performing the pi number transformation/inverse transformation processing S3 using the pi number transformation matrix P′_{pred} after the transformation and the physical quantity region D on the explanatory variable data vector xₒᵤₜ of physical quantities to be predicted, an explanatory variable data vector x′ₒᵤₜ of physical quantities physically similar to the explanatory variable data vector xₒᵤₜ of physical quantities to be predicted is obtained.

$${x}_{out} = ( {x}_{out , 1} , ⋯ , {x}_{out , n - 1} ) \\ {x}_{out}^{′} = ( {x}_{out , 1}^{′} , ⋯ , {x}_{out , n - 1}^{′} ) \\ {x}_{out}^{′} = {f}_{π}^{- 1} ∘ {f}_{π} ( {x}_{out} , {P}_{pred}^{′} , D ( X ) ) \qquad [ Formula 23 ]$$

Here, the processing in steps S600 to S602 (step S601 may be omitted) corresponds to the explanatory variable pi number transformation/inverse transformation processing S4. That is, the explanatory variable pi number transformation/inverse transformation processing S4 is processing in which when the pi number transformation matrix P_{conv} (=P′_{pred}) to be processed is input and the physical quantity data set Q and the explanatory variable data vector x of physical quantities (=xₒᵤₜ) are input, by performing the pi number transformation/inverse transformation processing S3 using the pi number transformation matrix P_{conv} to be processed and the physical quantity region D on the explanatory variable data vector x of physical quantities to be processed with the interpolation range D(X) of the physical quantity data set Q as the physical quantity region D, transformation is performed into the explanatory variable data vector x′ of physical quantities physically similar to the explanatory variable data vector x of physical quantities to be processed.

In the explanatory variable pi number transformation/inverse transformation processing S4 described above, the pi number transformation/inverse transformation processing S3 is performed only for the explanatory variables excluding the objective variable, but the explanatory variable pi number transformation/inverse transformation processing S4 is performed assuming that the physical quantity data vector q including the explanatory variable data vector x of physical quantities before transformation and the physical quantity data vector q′ including the explanatory variable data vector x′ of physical quantities after transformation satisfy a similarity relationship. Therefore, it can be said that the explanatory variable pi number transformation/inverse transformation processing S4 is processing in which transformation is performed into an explanatory variable data vector x′ of physical quantities concerning a phenomenon physically similar to the explanatory variable data vector x of physical quantities to be processed. In the present specification, the “physically similar explanatory variable data vector of physical quantities (similar explanatory variable data vector of variable quantities)” is used as a term representing “explanatory variable data vector of physical quantities concerning a physically similar phenomenon (explanatory variable data vector of variable quantities concerning a similar phenomenon)”.

It should be noted that the explanatory variable data vector x of physical quantities to be processed in the explanatory variable pi number transformation/inverse transformation processing S4 may exist in any of the interpolation range and the extrapolation range of the physical quantity data set Q. In addition, the explanatory variable pi number transformation/inverse transformation processing S4 incorporated in the phenomenon prediction processing S6 is basically performed on the explanatory variable data vector xₒᵤₜ of physical quantities to be predicted in a state where the objective variable data yₒᵤₜ of physical quantities is unknown. However, even when the objective variable data y of physical quantities is in a known state, the explanatory variable pi number transformation/inverse transformation processing S4 may be performed on the explanatory variable data vector x of physical quantities having a pair with the known objective variable data y of physical quantities.

Therefore, in step S602 shown in FIG. 8, the physically similar explanatory variable data vector x′ₒᵤₜ of physical quantities is obtained by performing the explanatory variable pi number transformation/inverse transformation processing S4 with the pi number transformation information P′_{pred} after the transformation, the physical quantity data set Q, and the explanatory variable data vector x of physical quantities to be predicted as inputs.

Next, in step S603, based on the physical quantity data set Q, a prediction model f_{reg} having the explanatory variable data vector x of physical quantities (explanatory variable set) as an input and the objective variable data y of physical quantities (objective variable) as an output is created. The prediction model f_{reg} is, for example, a regression model using a neural network (including deep learning), and is created by performing machine learning on a correlation between the explanatory variable data vector x of physical quantities and the objective variable data y of physical quantities using the physical quantity data set Q as learning data. It should be noted that the prediction model f_{reg} is not limited to the above example, and may be created by another method or model.

Next, in step S604, as shown in the following [Formula 24] equation, the physically similar explanatory variable data vector x′ₒᵤₜ of physical quantities obtained in step S602 is input to the prediction model f_{reg} created in step S603, thereby obtaining the objective variable data y′ₒᵤₜ of physical quantities by model prediction.

$${y}_{out}^{′} = {f}_{reg} ( {x}_{out}^{′} ) \qquad [ Formula 24 ]$$

Next, in step S605, as shown in the following [Formula 25] equation, by performing the pi number transformation processing S1 using the transformed pi number conversion matrix P′_{pred} after the transformation on the physical quantity data vector q′ₒᵤₜ having a pair of the objective variable data y′ₒᵤₜ of physical quantities by the model prediction obtained in step S604 and the physically similar explanatory variable data vector x′ₒᵤₜ of physical quantities obtained in step S602, the pi number data vector πₒᵤₜ after the transformation is obtained.

$${q}_{out}^{′} = ( {y}_{out}^{′} , {x}_{out , 1}^{′} , ⋯ , {x}_{out , n - 1}^{′} ) \\ {π}_{out} = {f}_{π} ( {q}_{out}^{′} , {P}_{pred}^{′} ) \qquad [ Formula 25 ]$$

Next, in step S606, as shown in the following [Formula 26] equation, by substituting the pi number data ηₒᵤₜ (=π_{out,1}) with respect to the particular pi number πᵥ₁ in the pi number data vector πₒᵤₜ after the transformation obtained in step S605 and the explanatory variable data vector xₒᵤₜ of physical quantities to be predicted into the definition formula of the particular pi number πᵥ₁, unknown objective variable data yₒᵤₜ of physical quantities is obtained. It should be noted that {p_{1,1}, p_{1,2}, . . . , p_{1,n}} represents each element of the pi number transformation vector p₁ in the first row in the pi number transformation matrix P′_{pred} after the transformation.

$$\begin{matrix}{π}_{out} = ( {π}_{out , 1} , {π}_{out , 2} , … , {π}_{out , n} ) = ( {η}_{out} , {ξ}_{out , 1} , … , {ξ}_{out , n - 1} ) \\ {π}_{out , 1} = {η}_{o u t} = {y}_{out}^{{p}_{1 , 1}} \cdot {x}_{out , 1}^{{p}_{1 , 2}} \cdot {x}_{out , 2}^{{p}_{1 , 3}} … {x}_{out , n - 1}^{{p}_{1 , n}} \\ {y}_{o u t} = {( \frac{{η}_{o u t}}{{x}_{out , 1}^{{p}_{1 , 2}} {x}_{out , 2}^{{p}_{1 , 3}} … {x}_{out , n - 1}^{{p}_{1 , n}}} )}^{\frac{1}{{p}_{1 , 1}}}\end{matrix} \qquad [ Formula 26 ]$$

As described above, in the phenomenon prediction processing S6 shown in FIG. 8, an unknown objective variable (objective variable data yₒᵤₜ of physical quantities) is predicted for the explanatory variable (explanatory variable data vector xₒᵤₜ of physical quantities) to be predicted using the pi number transformation matrix P. Let a series of processing by the phenomenon prediction processing S6 be expressed by the following [Formula 27].

$${y}_{o u t} = {f}_{p r e d , P} ( {x}_{out} , Q , {P}_{p r e d} ) \qquad [ Formula 27 ]$$

### (7-2) Verification Result of Prediction Performance by Phenomenon Prediction Processing S6

A result of verifying the prediction performance by the phenomenon prediction processing S6 using the physical quantity data set Q shown in the following [Table 3] will be described. The explanatory variable data vector x of physical quantities under 100 conditions included in each physical quantity data set Q was created as a random uniform distribution in the physical quantity region shown in [Table 3]. The value of the objective variable data y of physical quantities (wₘₐₓ) was created by obtaining an approximate solution of [Formula 2] equation from the explanatory variable data vector x of physical quantities. A pi number transformation matrix P representing Formula pi numbers πₘ (three in [Formula 4] equation) or physical pi numbers πₚ (two in [Formula 10] equation) was set as a pi number transformation matrix P_{pred} to be processed input in step S600, a physical quantity data set A was set as a physical quantity data set Q input in the phenomenon prediction processing step S600, the phenomenon prediction processing S6 was performed using each of explanatory variable data vectors x of physical quantities under 100 conditions included in the physical quantity data sets B, C, D, and E as an explanatory variable data vector of physical quantities to be predicted in phenomenon prediction processing input in step S600, and the predicted value of the objective variable data of physical quantities by the phenomenon prediction processing S6 was compared with the objective variable data (true value) of physical quantities included in the physical quantity data sets B, C, D, and E, whereby the prediction performance was verified.

TABLE 3

| | | | Range | | Range of | Physical quantity region of | | | |
|---|---|---|---|---|---|---|---|---|---|
| Physical | | Number | enlargement | | objective variable | explanatory variable | | | |
| quantity | | of | ratio | | D (Y) | D (X) | | | |
| data set | Application | conditions | R_{range} | | wₘₐₓ | p, Pa | a, mm | h, mm | E, GPa |
| A | Training | 100 | 1 | min | 2.26 | 10 | 1000 | 2 | 100 |
| | (input) | | (reference) | max | 7.96 | 15 | 1500 | 3 | 150 |
| | | | | max-min | 5.70 | 5 | 500 | 1 | 50 |
| B | Prediction | 100 | 2 | min | 1.24 | 10 | 1000 | 2 | 100 |
| | | | | max | 13.4 | 20 | 2000 | 4 | 200 |
| | | | | max-min | 12.2 | 10 | 1000 | 2 | 100 |
| C | | 100 | 3 | min | 0.94 | 10 | 1000 | 2 | 100 |
| | | | | max | 18.7 | 25 | 2500 | 5 | 250 |
| | | | | max-min | 17.8 | 15 | 1500 | 3 | 150 |
| D | | 100 | 4 | min | 0.31 | 10 | 1000 | 2 | 100 |
| | | | | max | 21.1 | 30 | 3000 | 6 | 300 |
| | | | | max-min | 20.8 | 20 | 2000 | 4 | 200 |
| E | | 100 | 5 | min | 0.11 | 10 | 1000 | 2 | 100 |
| | | | | max | 27.9 | 35 | 3500 | 7 | 350 |
| | | | | max-min | 27.8 | 25 | 2500 | 5 | 250 |

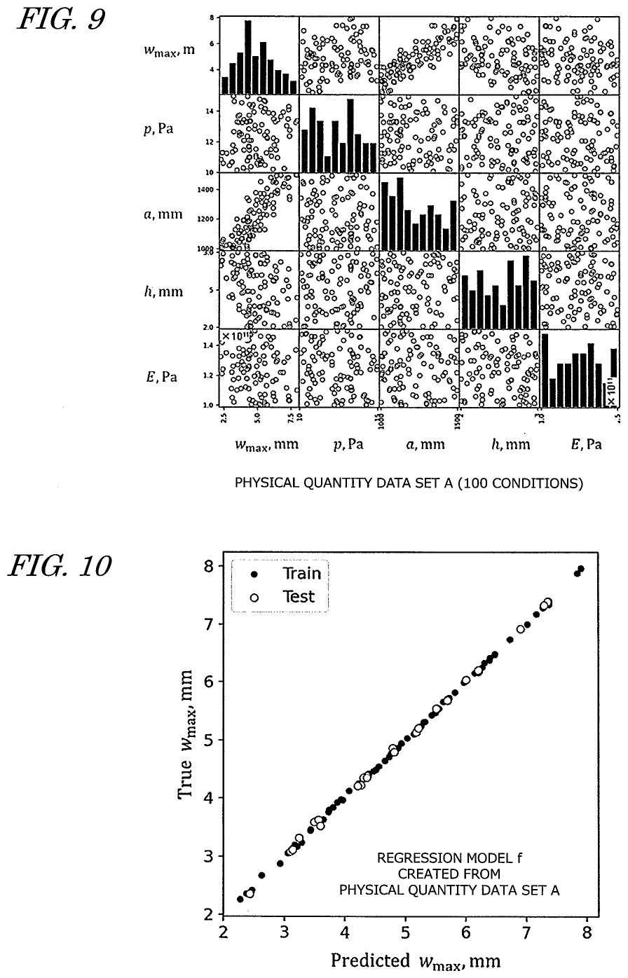

FIG. 9 is a scatter diagram matrix showing a physical quantity data set A for training. The diagonal graph represents a histogram of each physical quantity, and the other graphs represent scatter diagrams for all combinations of physical quantities.

FIG. 10 is a diagram showing the regression model f created from the physical quantity data set A. The horizontal axis represents the predicted value, and the vertical axis represents the correct answer (true value). A regression model f was created from the physical quantity data set A by a multilayer neural network (deep learning) using a machine learning tool. 75 conditions for training and 25 conditions for testing were used. The determination coefficients of the prediction value and the true value for each of training and testing were 1.000 and 0.999.

Here, among the explanatory variable data vectors x of physical quantities under 100 conditions included in the data set B, there is an explanatory variable data vector of physical quantities in which all the explanatory variables exist within the interpolation range (physical quantity region) that is the training range of the regression model f by the data set A. Therefore, among the randomly distributed explanatory variable data vectors x of physical quantities, the proportion of the regression model f existing within the interpolation range is defined as “predictability rate R_{pred}”. For example, in the physical quantity data set B, since the distribution range of all the explanatory variables of the data set A is twice, the probability that one explanatory variable is included in the interpolation range is 0.5. Therefore, since the predictability rate R_{pred} of the physical quantity data set B is calculated as a probability that all the four explanatory variables become interpolation, the predictability rate R_{pred}=0.54=0.063. That is, since the explanatory variable data vector x of physical quantities of 93.7% is to be extrapolated with respect to the regression model f, it is considered to be difficult to predict with the normal regression model f.

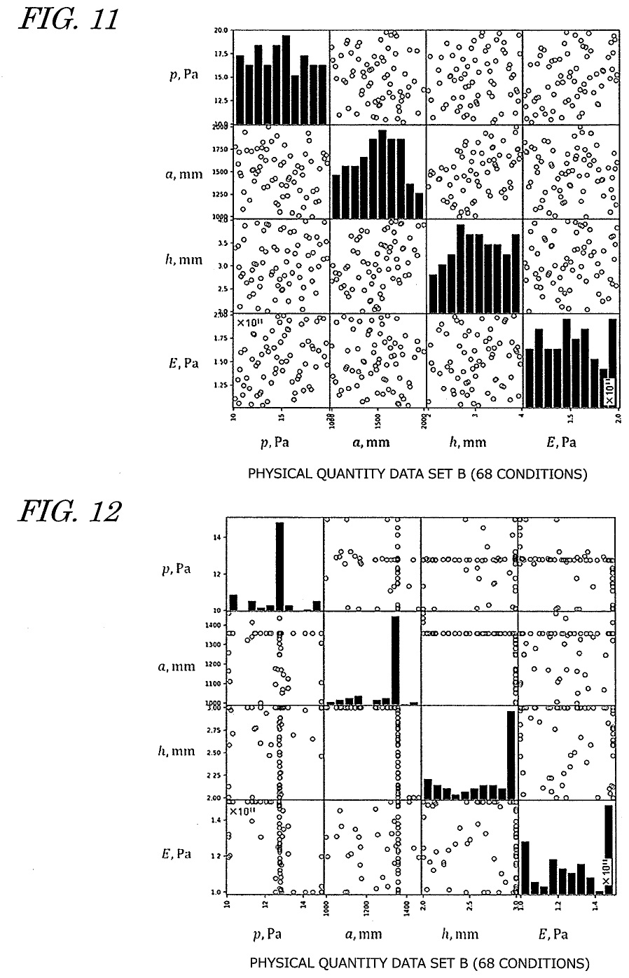

FIG. 11 is a scatter diagram matrix showing the explanatory variable data vector x of physical quantities of the physical quantity data set B transformed into the interpolation range of the regression model f by the pi number transformation/indefinite inverse transformation. Each point shown in FIG. 11 is a point representing the explanatory variable data vector x of physical quantities before the transformation transformed into the interpolation range of the regression model f when pi number transformation/indefinite inverse transformation by the pi number transformation matrix P representing the mathematical pi numbers of [Formula 4] equation (specifically, the explanatory variable pi number transformation/inverse transformation processing S4 using the explanatory variable data vector x of physical quantities, the data set A, and the pi number transformation matrix P representing the mathematical pi numbers as inputs) is performed on each of the explanatory variable data vectors x of physical quantities included in the physical quantity data set B. The number of points, that is, the number of explanatory variable data vectors x of physical quantities that can be transformed into the interpolation range of the regression model f (data set A) by the explanatory variable pi number transformation/inverse transformation processing S4 among explanatory variable data vectors x of physical quantities under the 100 conditions included in the physical quantity data set B, was 68. Therefore, the predictability rate R_{pred} is 0.68 (=68/100), which is much larger than the value of the normal regression model f (0.063 described above).

FIG. 12 is a scatter diagram matrix showing the physically similar explanatory variable data vector x′ of physical quantities of the physical quantity data set B transformed into the interpolation range of the regression model f by the pi number transformation/indefinite inverse transformation. Each point shown in FIG. 12 is a point representing a physically similar explanatory variable data vector x′ of physical quantities after the transformation transformed into the interpolation range of the regression model f when the explanatory variable pi number transformation/inverse transformation processing S4 having the same data as that in the case of FIG. 11 as an input is performed. Similarly to FIG. 11, the number of points is 68.

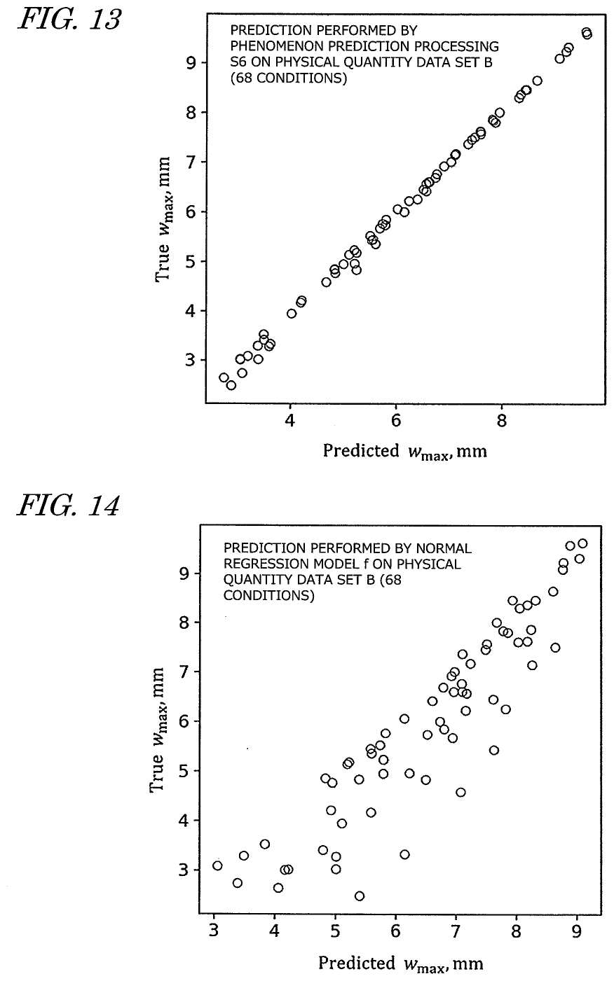

FIG. 13 is a diagram showing the result of performing the prediction of objective variables by the phenomenon prediction processing S6 on explanatory variables included in the physical quantity data set B. FIG. 14 is a diagram showing the result of performing the prediction of objective variables by the normal regression model f on explanatory variables included in the physical quantity data set B. The horizontal axis represents the predicted value and the vertical axis represents the correct answer (true value), and each point corresponds to 68 shown in FIGS. 11 and 12. In the prediction (see FIG. 13) by the phenomenon prediction processing S6 using the mathematical pi numbers πₘ of [Formula 4] equation, the determination coefficient of the predicted value and the correct answer is 0.995, and it has been found that the prediction can be performed with accuracy close to the interpolation data (physical quantity data set A for training) even for the extrapolation data including the explanatory variables existing in the extrapolation range of the physical quantity data set A for training, as with the physical quantity data set B. On the other hand, in the prediction using the normal regression model f (see FIG. 14), the determination coefficient is 0.737, and it has been found that the prediction accuracy is greatly reduced as compared with the phenomenon prediction processing S6.

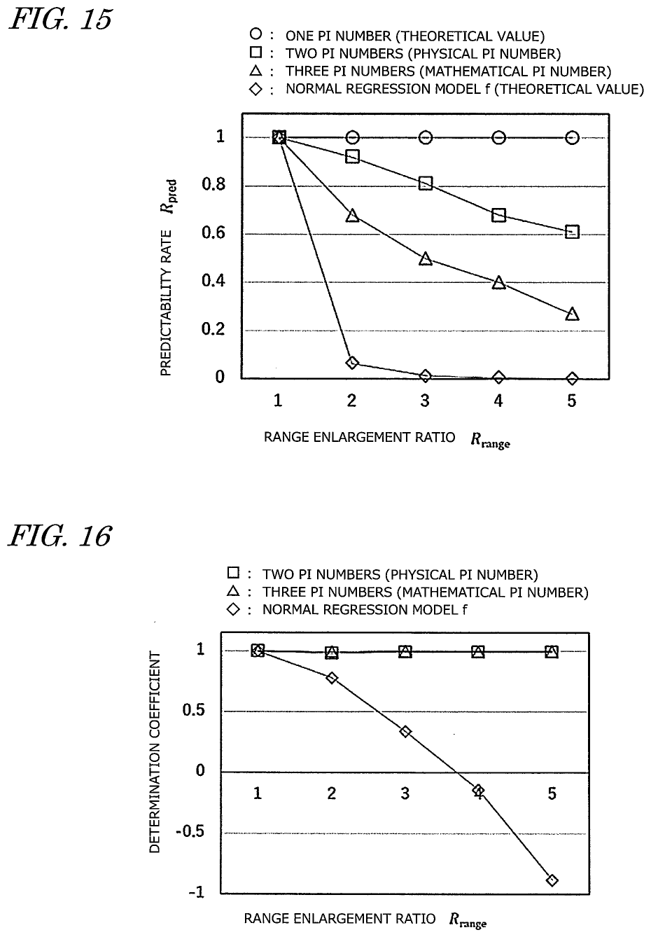

FIG. 15 is a diagram showing a comparison result obtained by comparing the dependency of the predictability rate R_{pred} on the range enlargement ratio R_{range} between the prediction by the phenomenon prediction processing S6 and the prediction by the normal regression model f. The predictability rate R_{pred} was calculated by the phenomenon prediction processing S6 that uses the respective mathematical pi numbers πₘ (3 in [Formula 4] equation) and physical pi numbers πₚ (2 in [Formula 10] equation). In addition, the predictability rate R_{pred} when the range enlargement ratios R_{range} are 2, 3, 4, and 5 was calculated using the physical quantity data sets B, C, D, and E shown in [Table 3], respectively.

In the case of the normal regression model f, the predictability rate R_{pred} is a theoretical value when the number of explanatory variables is four, and is a value obtained by multiplying the inverse of the range enlargement ratio R_{range} by itself, repeated for the number of explanatory variables. Therefore, the R_{pred} of the normal regression model f decreases exponentially with respect to the enlargement of the range enlargement ratio R_{range}.

On the other hand, it was found that the prediction by the phenomenon prediction processing S6 using the pi numbers is remarkably higher in the predictability rate R_{pred} than the prediction by the normal regression model f. In addition, it was found that the smaller the number of pi numbers, the higher the predictability rate R_{pred}. In particular, in the approximate pi numbers Ta, since the number of pi numbers is one and F(πₐ₁)=0, π₁ has no degree of freedom as a variable, and π₁=const. That is, since the value of the pi number is a constant value in all similar physical phenomena, the value of the objective variable is determined immediately when the values of the explanatory variables are given. Therefore, regardless of the setting of the extrapolation range, the predictability rate R_{pred} is always 1.

FIG. 16 is a diagram showing a comparison result obtained by comparing the determination coefficients of the predicted value and the correct answer (true value) in the prediction by the phenomenon prediction processing S6 and the prediction by the normal regression model f. The determination coefficient of the normal regression model f shown in FIG. 16 is obtained by adopting a higher value out of the determination coefficient in a case where the normal regression model f predicts a condition that can be predicted by the phenomenon prediction processing S6 using the physical pi numbers and the determination coefficient in a case where the normal regression model f predicts a condition that can be predicted by the phenomenon prediction processing S6 using the mathematical pi numbers. It was found that the determination coefficient of the phenomenon prediction processing S6 using the pi numbers does not decrease even when the range enlargement ratio R_{range} increases, unlike the case of the normal regression model f.

### (8-1) Pi Number Validity Evaluation Processing S7

The pi number validity evaluation processing S7 is processing in which when new pi numbers of some kind (specifically, the pi number transformation matrix Pₑᵥₐₗ to be processed) are obtained for the physical quantity data set Q observed in a predetermined phenomenon, the validity of the pi numbers is evaluated from the physical quantity data set Q.

The new pi numbers, that is, the pi number transformation matrix Pₑᵥₐₗ to be processed, may be those optional, and for example, may be those generated using an automatic generation function implemented in the pi number search processing S8 described below, or may be those generated by a data analyst.

In the pi number validity evaluation processing S7, two indexes of “similarity transformation validity” and “relational expression existence” are introduced as indexes for evaluating the validity of the pi numbers, and the validity of the pi numbers is evaluated based on at least one of the evaluation result of the similarity transformation validity by the similarity transformation validity evaluation processing S71 and the evaluation result of the relational expression existence by the relational expression existence evaluation processing S72.

In the former “similarity transformation validity”, the validity of pi numbers is evaluated based on accuracy when a physically similar physical quantity data vector q′ after the transformation is obtained from the physical quantity data vector q before the transformation by the pi number transformation/indefinite inverse transformation (specifically, the self-space pi number transformation/inverse transformation processing S5) using the pi number transformation matrix Pₑᵥₐₗ to be processed. In the evaluation of “similarity transformation validity”, the pieces of data for testing of the same number as the number of conditions (the number of pieces of data) of the physical quantity data set Q can be created and used in principle by using the self-space pi number transformation/inverse transformation processing S5, and thus, the data use efficiency is high.

In the latter “relational expression existence”, the validity of the pi numbers is evaluated based on the degree of existence of the relational expression F (see [Formula 5] equation) of the pi numbers ensured by Buckingham's Pi theorem between a plurality of pi numbers determined by the pi number transformation matrix Pₑᵥₐₗ to be processed. When the pi number transformation matrix Pₑᵥₐₗ to be processed is different from the correct pi numbers representing a predetermined phenomenon, the relational expression F of the pi numbers is not established, and such a relational expression F cannot be definitely identified. Using this property, the degree of existence of the relational expression F approximately established between the pi numbers can be regarded as an index representing the validity of the pi numbers. Therefore, in the evaluation of the “relational expression existence”, the degree of existence of the relational expression F is evaluated by the perfection degree of the prediction model f_{reg} created from the physical quantity data set Q by machine learning. Therefore, in the evaluation of the former “similarity transformation validity”, it may be difficult to perform the self-space pi number transformation/inverse transformation processing S5 on some pi number forms (for example, when the physical quantities itself is initially set as a temporary pi number at the time of searching for the pi numbers from the physical quantities, or the like), but in the latter evaluation of the “relational expression existence”, there is no influence by such a pi number form.

### (8-2) Similarity Transformation Validity Evaluation Processing S71

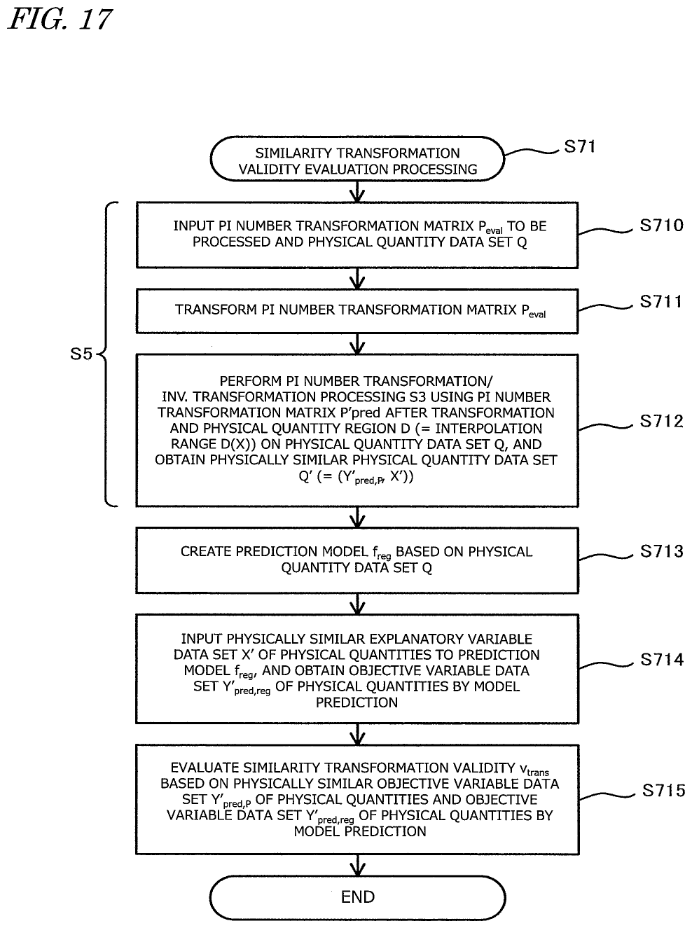

FIG. 17 is a flowchart showing an example of the similarity transformation validity evaluation processing S71.

First, in step S710, the pi number transformation matrix Pₑᵥₐₗ to be processed is input, and the physical quantity data set Q is input. Since the details of step S710 are similar to those of step S600, the description thereof will be omitted.

Next, in step S711, by transforming the pi number transformation matrix Pₑᵥₐₗ to be processed so that the exponents of the objective variable included in the pi number πᵥ are 0 except for the particular pi number πᵥ₁, the pi number transformation matrix P′ₑᵥₐₗ after the transformation is created. It should be noted that since the details of step S711 are similar to those of step S601, the description thereof will be omitted.

Next, as shown in the following [Formula 28] equation, in step S712, with an interpolation range D(X) of the explanatory variable data set X of physical quantities which is a set of the explanatory variable data vectors x of physical quantities included in the physical quantity data set Q as the physical quantity region D, by performing the pi number transformation/inverse transformation processing S3 using the pi number transformation matrix P′ₑᵥₐₗ after the transformation and the physical quantity region D on the physical quantity data vector q included in the physical quantity data set Q, a physical quantity data vector q′ physically similar to the physical quantity data vector q is obtained.

$${q}_{i}^{′} = {f}_{π}^{- 1} ∘ {f}_{π} ( {q}_{i} , {P}_{pred}^{′} , D ( X ) ) \qquad [ Formula 28 ]$$

Then, in step S712, as shown in the following [Formula 29] equation, by performing the pi number transformation/inverse transformation processing S3 using the pi number transformation matrix P′ₑᵥₐₗ after the transformation and the physical quantity region D on each of all the physical quantity data vectors q included in the physical quantity data set Q, a physical quantity data set Q′ physically similar to the physical quantity data set Q is obtained. Let the objective variable data set Y′ of physical quantities included in the physically similar physical quantity data set Q′ obtained in step S712 be represented as “objective variable data set Y′_{pred,P} of physical quantities”.

$$\begin{matrix}{Q}^{′} = ( {X}^{′} , {Y}^{′} ) = {f}_{π}^{- 1} ∘ {f}_{π} ( Q , {P}_{p r e d}^{′} , D ( X ) ) \\ {Y}_{pred , P}^{′} = {Y}^{′}\end{matrix} \qquad [ Formula 29 ]$$

Here, the processing in steps S710 to S712 (step S711 may be omitted) corresponds to the self-space pi number transformation/inverse transformation processing S5.

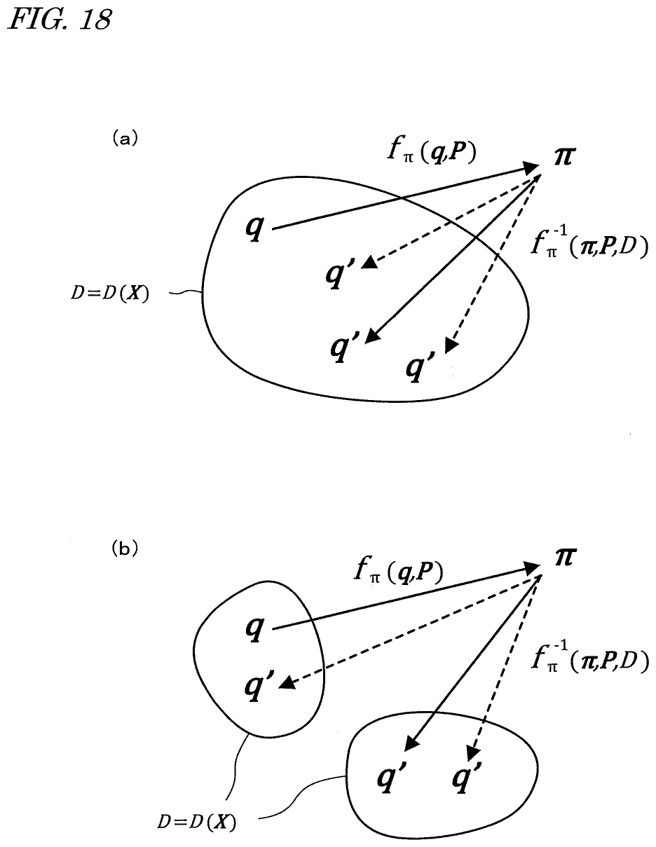

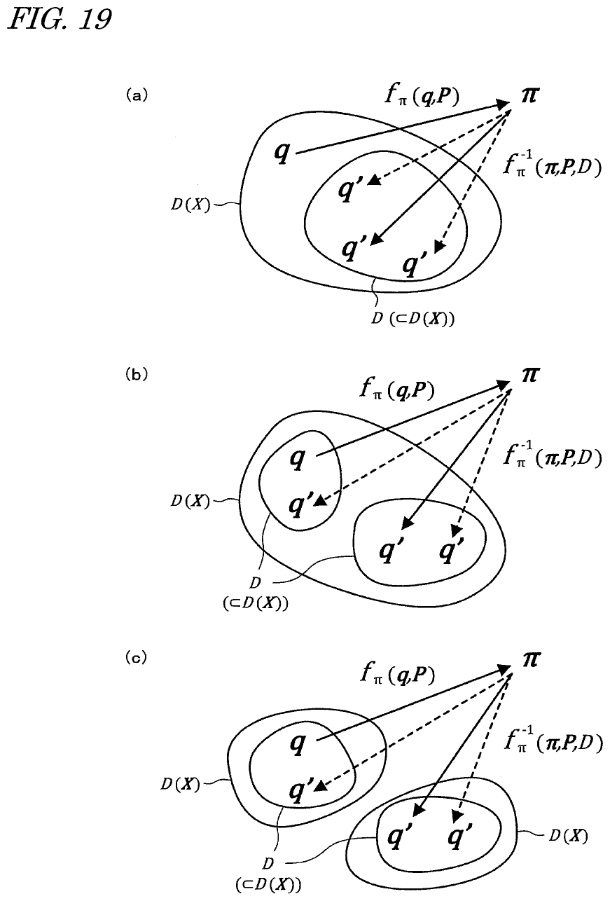

FIG. 18 is a first schematic diagram showing the self-space pi number transformation/indefinite inverse transformation by the self-space pi number transformation/inverse transformation processing S5. FIG. 19 is a second schematic diagram showing the self-space pi number transformation/indefinite inverse transformation by the self-space pi number transformation/inverse transformation processing S5.

The self-space pi number transformation/inverse transformation processing S5 is processing in which when the pi number transformation matrix P_{conv} (=P′ₑᵥₐₗ) to be processed is input and the physical quantity data set Q is input, by performing the pi number transformation/inverse transformation processing S3 so that the physical quantity data vector q included in the physical quantity data set Q is included in the self-space determined by the physical quantity data set Q, transformation is performed into a physical quantity data vector q′ physically similar to the physical quantity data vector q. Let such transformation be referred to as “self-space pi number transformation/indefinite inverse transformation”. The self-space pi number transformation/indefinite inverse transformation by the self-space pi number transformation/inverse transformation processing S5 is expressed by [Formula 28] equation or [Formula 29] equation.

As shown in FIGS. 18(a) and 18(b), when the self-space determined by the physical quantity data set Q is the same range as the interpolation range D(X) of the explanatory variable data set X of physical quantities, the self-space pi number transformation/inverse transformation processing S5 performs the pi number transformation/inverse transformation processing S3 using the pi number transformation matrix P_{conv} to be processed and the physical quantity region D, with the interpolation range D(X) as the physical quantity region D. It should be noted that as shown in FIG. 18(b), the interpolation range D(X) may be divided into a plurality of pieces according to the physical quantity data set Q.

In addition, as shown in FIGS. 19(a) to 19(c), when the self-space determined by the physical quantity data set Q is a limited region limited to a range narrower than the interpolation range D(X) of the explanatory variable data set X of physical quantities, the self-space pi number transformation/inverse transformation processing S5 performs the pi number transformation/inverse transformation processing S3 using the pi number transformation matrix P_{conv} to be processed and the physical quantity region D, with the limited region as the physical quantity region D. As shown in FIG. 19(c), the interpolation range D(X) may be divided into a plurality of pieces according to the physical quantity data set Q. In addition, which range the limited region is limited to only needs to be determined according to the purpose of the data analysis, and for example, the limited region may be limited to a range in which the explanatory variable data vectors x of physical quantities are densely present, or may be limited according to the designation of the data analyst.

It should be noted that in the pi number inverse transformation included in the self-space pi number transformation/inverse transformation processing S5, since a solution is obtained by numerical analysis, a physical quantity data vector q′ different from the physical quantity data vector q is basically obtained. However, since the same solution (q=q′) also exists, there is also a possibility of converging to the same solution by numerical analysis. As a countermeasure thereof, the initial distribution at the time of the pi number inverse transformation may be given as random numbers.

Therefore, in step S712 shown in FIG. 17, the physically similar explanatory variable data vector x′ₒᵤₜ of physical quantities is obtained by performing the self-space pi number transformation/inverse transformation processing S5, with the pi number transformation information P′ₑᵥₐₗ after the transformation and the physical quantity data set Q as inputs.

Next, in step S713, based on the physical quantity data set Q, a prediction model f_{reg} having the explanatory variable data vector x of physical quantities (explanatory variable set) as an input and the objective variable data y (objective variable) of physical quantities as an output is created. Since the details of step S713 are similar to those of step S603, the description thereof will be omitted.

Next, in step S714, as shown in the following [Formula 30] equation, by inputting, to the prediction model f_{reg} created in step S713, an explanatory variable data set X′ of physical quantities being a set of physically similar explanatory variable data vectors x′ₒᵤₜ of physical quantities included in the physical quantity data set Q′ physically similar to the physical quantity data set Q, an objective variable data set Y′_{pred,reg} of physical quantities by model prediction is obtained.

$${Y}_{pred , reg}^{′} = {f}_{r e g} ( {X}^{′} ) \qquad [ Formula 30 ]$$

Next, in step S715, the similarity transformation validity vₜᵣₐₙₛ is evaluated based on the physically similar objective variable data set Y′_{pred,P} of physical quantities obtained in step S712 and the objective variable data set Y′_{pred,reg} of physical quantities by model prediction obtained in step S714, as shown in the following [Formula 31] equation. In [Formula 31] equation, let R² represent a determination coefficient of two data sets of an argument.

$$\begin{matrix}{v}_{trans} = \frac{{R}_{P}^{2} - {R}_{trans}^{2}}{{R}_{model}^{2} - {R}_{trans}^{2}} \\ {R}_{P}^{2} ≡ {R}^{2} ( {Y}_{p r e d , P}^{′} , {Y}_{pred , reg}^{′} ) \\ {R}_{trans}^{2} ≡ {R}^{2} ( {Y}_{pred , reg}^{′} , Y )\end{matrix} \qquad [ Formula 31 ]$$

As the determination coefficient R²_{P} is larger, it is considered that the similarity transformation validity vₜᵣₐₙₛ of the pi number transformation matrix Pₑᵥₐₗ to be processed is higher. However, it is considered that the similarity transformation validity vₜᵣₐₙₛ is affected by the perfection degree of the prediction model f_{reg} and the distribution of the physically similar explanatory variable data set X′ of physical quantities.

For example, it can be said that the smaller the determination coefficient R²ₜᵣₐₙₛ, the larger the change in the distribution of the physically similar explanatory variable data set X′ of physical quantities with respect to the distribution of the explanatory variable data set X of physical quantities, which is suitable for the data for testing. In addition, the lower the perfection degree of the prediction model f_{reg}, the smaller the determination coefficient R²_{model}. Even if the pi number transformation/indefinite inverse transformation is accurate, it is difficult to exceed the value of the determination coefficient R²_{model} except for an error and a stochastic element. Therefore, the numerator on the right side of [Formula 31] equation represents the accuracy of the pi number transformation/indefinite inverse transformation with reference to the data for testing, and the denominator on the right side of [Formula 31] equation represents the perfection degree of the regression model with reference to the quality of the data for testing. Therefore, the similarity transformation validity vₜᵣₐₙₛ obtained by [Formula 31] equation represents the accuracy of the pi number transformation/inverse transformation when the quality (R²ₜᵣₐₙₛ) of the data for testing and the perfection degree (R²_{model}) of the prediction model f_{reg} are used as references. Therefore, it is less susceptible to the perfection degree of the prediction model f_{reg} and the accuracy of the self-space pi number transformation/indefinite inverse transformation than the determination coefficient R²_{P} itself.

As described above, in the similarity transformation validity evaluation processing S71 shown in FIG. 17, the validity of the pi number transformation matrix Pₑᵥₐₗ is evaluated based on the similarity transformation validity vₜᵣₐₙₛ representing the accuracy of transformation when the self-space pi number transformation/inverse transformation processing S5 by the pi number transformation matrix Pₑᵥₐₗ to be processed is performed on the physical quantity data set Q. It should be noted that the similarity transformation validity vₜᵣₐₙₛ only needs to be an evaluation value representing the accuracy of transformation, and the determination coefficient R²_{P} may be used as the similarity transformation validity vₜᵣₐₙₛ as it is, or may be obtained by a method other than the [Formula 31] equation.

In addition, in the similarity transformation validity evaluation processing S71, when the pi number πᵥ₁ is in a form equal to the objective variable (πᵥ1=qᵥ₁) and the pi number transformation/indefinite inverse transformation is accurate (that is, the pi number is valid), the determination coefficient R²ₜᵣₐₙₛ does not function. This is because the explanatory variable data vector xᵢ of physical quantities is different from the physically similar explanatory variable data vector x′ᵢ of physical quantities, but a physical quantity data vector q′ᵢ can be obtained in which the objective variable data yᵢ of physical quantities is substantially equal to the physically similar objective variable data y′ᵢ of physical quantities. When the pi number transformation/indefinite inverse transformation is accurate, the objective variable data set Y of physical quantities and the physically similar objective variable data set Y′_{pred,P} of physical quantities obtained in step S712 are substantially equal. Therefore, the determination coefficient R²_{P} and the determination coefficient R²ₜᵣₐₙₛ are substantially equal, and the similarity transformation validity vₜᵣₐₙₛ is substantially 0. In order to avoid this, only when calculating the determination coefficient R²ₜᵣₐₙₛ, the explanatory variable data set X of physical quantities” after the transformation obtained by transforming all the components of the explanatory variable data set X of physical quantities' by the following [Formula 32] equation is used.

$$\begin{matrix}if & δ = 1 , \\ & {x}_{i , j}^{′′} = min ( {x}_{i , j} + δ ( {x}_{i j}^{′} - {x}_{i , j} ) , {max}_{i = 1 , … , s} ( {x}_{i , j} ) ) \\ if & δ = - 1 , \\ & {x}_{i , j}^{′′} = min ( {x}_{i , j} + δ ( {x}_{i j}^{′} - {x}_{i , j} ) , {max}_{i = 1 , … , s} ( {x}_{i , j} ) )\end{matrix} \qquad [ Formula 32 ]$$

Here, δ is a coefficient that has a value of +1 with a probability of 0.5 at random for each data. That is, the direction is changed with a probability of 0.5 while maintaining the width moved by the pi number transformation/indefinite inverse transformation. Since the objective variable data set Y′_{pred,reg} of physical quantities by the model prediction used for calculation of the determination coefficient R²ₜᵣₐₙₛ has a role for reflecting the degree of change from the explanatory variable data set X of physical quantities to the physically similar explanatory variable data set X′ of physical quantities in the objective variable data set Y of physical quantities, the role is achieved even if the moving direction is changed. By this processing, even when the pi numbers are valid, it is reflected in the objective variable data set Y′_{pred,reg} of physical quantities by model prediction.

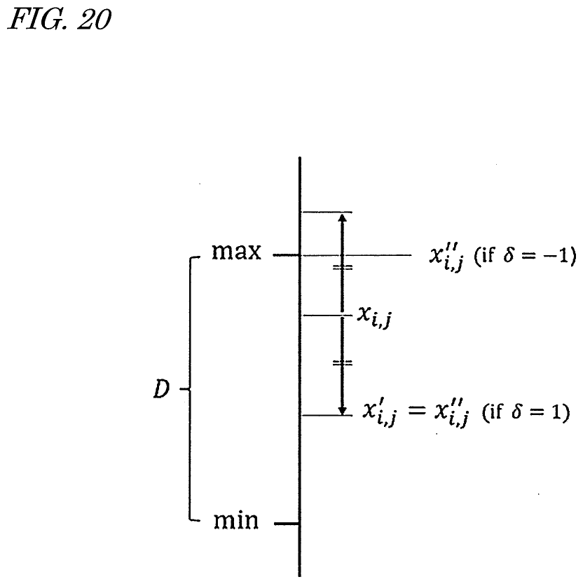

FIG. 20 is a diagram showing an example of a method of correcting the explanatory variable data vector x′ᵢ of physical quantities. The lengths of the two arrows in opposite directions are equal. A case is illustrated where the explanatory variable data vector x″_{i,j} of physical quantities is limited to the upper limit of the physical quantity region D, and the movement amount from the explanatory variable data vector x_{i,j} of physical quantities to the explanatory variable data vector x″_{i,j} of physical quantities is smaller than the movement amount from the explanatory variable data vector x_{i,j} of physical quantities to the explanatory variable data vector x′_{i,j} of physical quantities. The reason for random shaking is that if δ=−1 at all times, when a set of explanatory variables (a form such as qᵥ₂/qᵥ₃) is included in the numerator and the denominator included in the pi numbers, each of the explanatory variables changes in the same direction, so that a change as the pi numbers decreases, and when the pi numbers are valid, it is desired to avoid an increase in the determination coefficient R²ₜᵣₐₙₛ due to the above. The calculation of the maximum value max and the minimum value min is limited so that q″_{i,x} does not exceed the interpolation range D(X). However, the average value of the distances (x′_{i,j}−x_{i,j}) that would have moved if not limited becomes small. Therefore, the determination coefficient R²ₜᵣₐₙₛ is multiplied by the coefficient c of the following equation and corrected.

$$c = \frac{{\sum }_{i , j} {( {x}_{i , j}^{′} - {x}_{i , j} )}^{2}}{{\sum }_{i , j} {( {x}_{i , j}^{″} - {x}_{i , j} )}^{2}} \qquad [ Formula 33 ]$$

By using the coefficient c described above, instead of the [Formula 30] equation and [Formula 31] equation, the determination coefficient R²ₜᵣₐₙₛ of the pi number transformation/indefinite inverse transformation with the data for testing as a reference is calculated by the following [Formula 34] equation. Accordingly, even when the pi number 1v1 is equal to the objective variable (πᵥ₁=qᵥ₁), when the pi number transformation/indefinite inverse transformation is accurate, the similarity transformation validity vₜᵣₐₙₛ is obtained as a high value.

$$\begin{matrix}{Y}_{pred , reg}^{″} = {f}_{reg} ( {X}^{″} ) \\ {R}_{trans}^{2} ≡ {cR}^{2} ( {Y}_{pred , reg}^{″} , Y )\end{matrix} \qquad [ Formula 34 ]$$

### (8-3) Relational Expression Existence Evaluation Processing S72

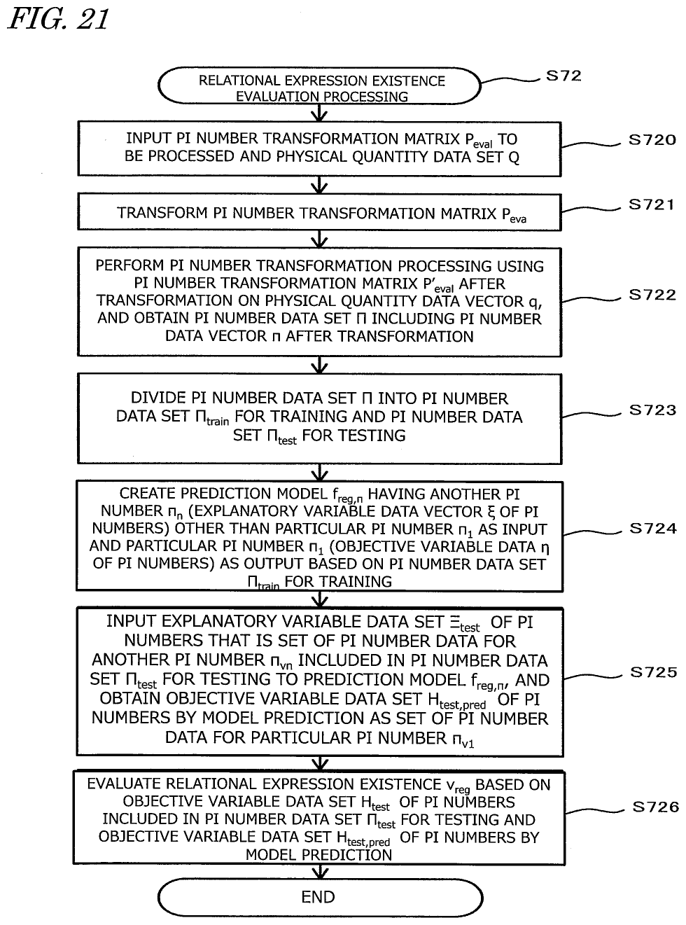

FIG. 21 is a flowchart showing an example of the relational expression existence evaluation processing S72.

First, in step S720, the pi number transformation matrix Pₑᵥₐₗ to be processed is input, and the physical quantity data set Q is input. Since the details of step S720 are similar to those of step S600, the description thereof will be omitted.

Next, in step S721, by transforming the pi number transformation matrix Pₑᵥₐₗ to be processed so that the exponents of the objective variable included in the pi number are 0 except for the particular pi number πᵥ₁, the pi number transformation matrix P′ₑᵥₐₗ after the transformation is created. It should be noted that since the details of step S721 are similar to those of step S601, the description thereof will be omitted.

Next, in step S722, as shown in the following [Formula 35] equation, by performing the pi number transformation processing using the pi number transformation matrix P′ₑᵥₐₗ after the transformation on each of the physical quantity data vectors q included in the physical quantity data set Q, a pi number data set II including the pi number data vectors π after the transformation is obtained.

$$Π = {f}_{π} ( Q , {P}_{eval}^{′} ) \qquad [ Formula 35 ]$$

Next, in step S723, the pi number data set II obtained in step S722 is divided into a pi number data set Πₜᵣₐᵢₙ for training and a pi number data set Πₜₑₛₜ for testing. The proportion for dividing the pi number data set II may be appropriately determined.

Next, in step S724, a prediction model f_{reg}, in which another pi number πᵥₙ (the explanatory variable data vector ξ of pi numbers) other than the particular pi number πᵥ₁ is set as input and the particular pi number πᵥ₁ (objective variable data η of pi numbers) is set as output is created based on the pi number data set Πₜᵣₐᵢₙ for training.

Next, in step S725, as shown by the following [Formula 36] equation, by inputting the explanatory variable data set Ξₜₑₛₜ of pi numbers, which is a set of pi number data for another pi number πᵥₙ (explanatory variable data vector ξ of pi numbers) included in the pi number data set Πₜₑₛₜ for testing, to the prediction model f_{reg,π}, an objective variable data set H_{test,pred} of pi numbers by model prediction is obtained as a set of pi number data for a particular pi number πᵥ₁.

$$\begin{matrix}{Π}_{t e s 𝔱} = ( {H}_{test} , {Ξ}_{test} ) \\ {H}_{test , pred} = {f}_{reg , π} ( {Ξ}_{test} )\end{matrix} \qquad [ Formula 36 ]$$

Next, in step S726, as shown in the following [Formula 37] equation, the relational expression existence v_{reg} is evaluated based on the objective variable data set Hₜₑₛₜ of pi numbers which is a set of the pi number data for a particular pi number πᵥ₁ (objective variable data n of pi numbers) included in the pi number data set Πₜₑₛₜ for testing and the objective variable data set H_{test,pred} of pi numbers by model prediction. In [Formula 37] equation, let R² represent a determination coefficient of two data sets of an argument.

$${v}_{r e g} = {R}^{2} ( {H}_{test , pred} , {H}_{t e s t} ) \qquad [ Formula 37 ]$$

Examples of the relational expression existence v_{reg} include a determination coefficient obtained from a prediction value (H_{test,pred}) by the prediction model f_{reg,x} and the true value (Hₜₑₛₜ). It is considered that the larger the determination coefficient R², the higher the relational expression existence v_{reg} of the pi number transformation matrix Pₑᵥₐₗ to be processed. It should be noted that the relational expression existence v_{reg} only needs to be an evaluation value representing the degree of existence of the relational expression F, and may be obtained by a method other than the [Formula 37] equation.

As described above, in the relational expression existence evaluation processing S72 shown in FIG. 21, the validity of the pi number transformation matrix Pₑᵥₐₗ is evaluated based on the relational expression existence v_{reg} representing the degree of existence of the relational expression F of the pi number ensured by Buckingham's Pi theorem between the plurality of pi numbers determined by the pi number transformation matrix Pₑᵥₐₗ to be processed.

### (9) Pi Number Search Processing S8

The pi number search processing S8 is processing in which although the theoretical equation (for example, in a physical phenomenon of a disk, a governing equation shown in [Formula 2] equation) established by the predetermined phenomenon is unknown, in a situation where the physical quantity data set Q observed in the phenomenon and the candidates for the pi numbers representing the phenomenon (specifically, the candidate P_{c} for the pi number transformation matrix to be processed) are obtained, by repeatedly performing new candidate generation processing S81 of generating a new candidate P_{new} from the candidate Pc and pi number validity evaluation processing S7 using the new candidate P_{new} generated by the new candidate generation processing S81 and the physical quantity data set Q as inputs, a pi number transformation matrix P_{best} satisfying a predetermined condition is searched. The predetermined condition may be based on the evaluation result of validity by the pi number validity evaluation processing S7, or other conditions such as the number k of pi numbers and the number of times of processing may be considered.

The candidate P_{C} at the initial stage of the pi numbers in the pi number search processing S8 may be optional, for example, may be a pi number transformation matrix P representing mathematical pi numbers obtained as a result of the dimensional analysis, may be a pi number transformation matrix P (unit matrix in which the number of physical quantities is rank) in which the physical quantity set Qv is adopted as the pi numbers as it is, may be generated by a data analyst, or may be an appropriate combination of these.

In the pi number search processing S8, in the new candidate generation processing S81, a new candidate P_{new} is generated with the candidate Pc at the initial stage of the pi numbers as a starting point, the validity of the new candidate P_{new} is evaluated by applying the pi number validity evaluation processing S7 to the generated new candidate P_{new}, and the allowability of adopting the new candidate P_{new} or the allowability of deleting an unnecessary candidate Pc is determined based on the evaluation result. By repeating such a series of processing, the final pi number transformation matrix P_{best} is searched. As a result of the search by the pi number search processing S8, as the final pi number transformation matrix P_{best}, for example, a physical pi number, an approximate pi number, and the like are derived when the mathematical pi number is set as a candidate Pc in the initial stage, or a mathematical pi number, a physical pi number, an approximate pi number, and the like are derived when the unit matrix of the physical quantity set Qv is set as a candidate Pc in the initial stage.

In the new candidate generation processing S81, one or two pi number transformation vectors are selected from a plurality of pi number transformation vectors included in the candidate Pc, a new pi number transformation vector p_{new} is generated based on a combination of weighted sums of the one or two pi number transformation vectors, and the new pi number transformation vector p_{new} is added to the candidate Pc, whereby a new candidate P_{new} is generated.

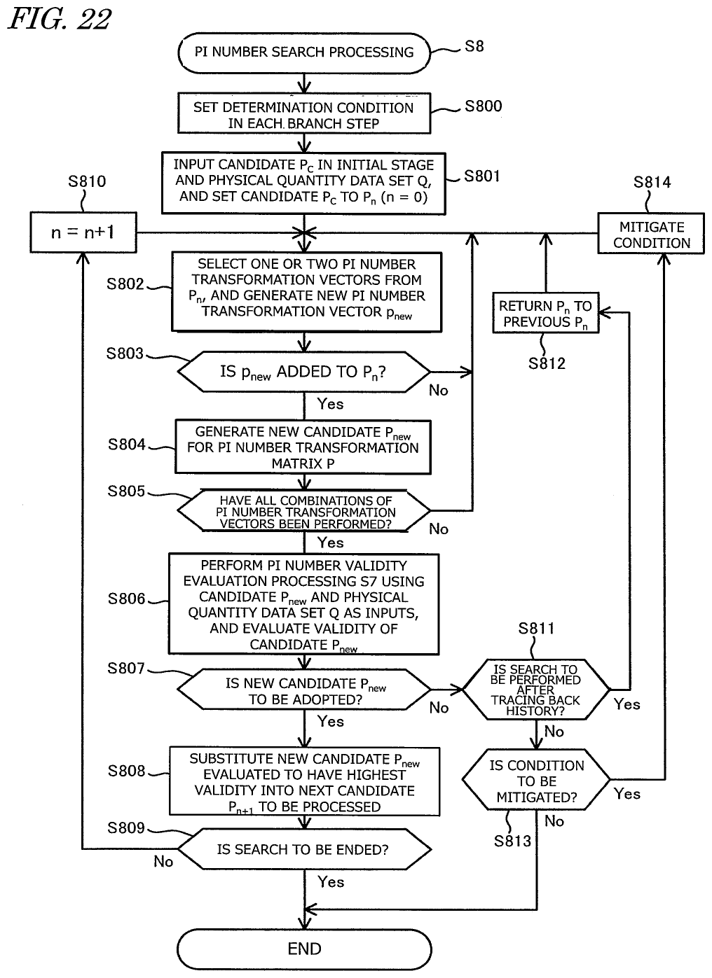

FIG. 22 is a flowchart showing an example of the pi number search processing S8.

First, in step S800, a determination condition in each of the subsequent branch steps is set.

Next, in step S801, the candidate Pc in the initial stage is input, and the physical quantity data set Q is input. The candidate Pc in the initial stage is set to a pi number transformation matrix Pₙ for a search loop (temporary variable n=0). The temporary variable n is a variable for the search loop.

Next, in step S802, one or two pi number transformation vectors are selected from the plurality of pi number transformation vectors included in the pi number transformation matrix Pₙ for the search loop, and a new pi number transformation vector P_{new} is generated. As a method for generating a new pi number transformation vector P_{new}, in the present embodiment, a case will be described where a first generation method of generating a new pi number transformation vector P_{new} from two pi number transformation vectors and a second generation method of generating a new pi number transformation vector P_{new} from one pi number transformation vector are used in combination.

In the first generation method, as shown in the following [Formula 38] equation, a new pi number transformation vector p_{new} is generated based on a combination of weighted sums of the two pi number transformation vectors pᵢ and pⱼ.

$${p}_{new} = α {p}_{i} + β {p}_{j} \qquad [ Formula 38 ]$$

At that time, by setting the coefficients α and β in the [Formula 38] equation according to the conditions shown in the following [Formula 39] equation, a new pi number transformation vector p_{new} is generated from a combination of weighted sums of the two pi number transformation vectors pᵢ and pⱼ. This corresponds to creating a combination of exponential products for the two pi numbers πᵢ and xⱼ corresponding to the two pi number transformation vectors pᵢ and pⱼ.

$$\begin{matrix}1 \leq i < j \leq k \\ ( α , β ) = ( 1 , 1 ) , ( 1 , - 1 )\end{matrix} \qquad [ Formula 39 ]$$

A variable k in [Formula 39] equation represents the number of pi number vectors included in Pₙ at that time. In addition, since the inverse of the pi number is the same pi number, α=−1 is not considered in the [Formula 39] equation.

In the second generation method, let a value obtained by adding 1 to the first component p_{1,1} of the pi number transformation vector p₁ in the first row be set as a new pi number transformation vector p_{new}. This is because a pi number in which the exponent of an objective variable is 2 or more is also to be searched.

It should be noted that, in the present embodiment, in the first and second generation methods described above, a new pi number transformation vector p_{new} is generated so that the objective variable is included only in the numerator of the pi number πᵥ₁ which is the first component of the pi number set Πv. That is, the component p_{1,1} in the first row and the first column in the pi number transformation matrix P is a natural number, and the components p_{2,1} to p_{k,1} (components in the second and subsequent rows in the first column) are all 0. Considering that the inverse of the pi number is regarded as the same pi number, the objective variable may be limited to a form included only in the numerator of the pi number πᵥ₁ which is the first component of the pi number set Πv.

Next, in step S803, it is determined whether to add the new pi number transformation vector p_{new} generated by the first and second generation methods to the candidate Pₙ for the pi number transformation matrix P. When the new pi number transformation vector p_{new} is, for example, already included in the candidate Pₙ, it is determined that the new pi number transformation vector p_{new} is not added to the candidate Pₙ. Then, if it is determined as “Yes” in step S803, the process proceeds to step S804, and if it is determined as “No”, the process returns to step S802.

Next, in step S804, by adding a new pi number transformation vector p_{new} generated by the first and second generation methods to the candidate Pₙ, a new candidate P_{new} of the pi number transformation matrix P is generated.

At that time, by making the method of deleting the two pi number transformation vectors pᵢ and pⱼ different when the new pi number transformation vector P_{new} is generated by the first generation method, for example, each of the following is generated as a new candidate P_{new}: (1) a pi number transformation matrix P in which a new pi number transformation vector P_{new} is added to the candidate Pₙ and the one pi number transformation vectors pᵢ is deleted, (2) a pi number transformation matrix P in which a new pi number transformation vector p_{new} is added to the candidate Pₙ and the other pi number transformation vector pⱼ is deleted, and (3) a pi number transformation matrix P in which a new pi number transformation vector p_{new} is added to the candidate Pₙ and both of the two pi number transformation vectors pi and pⱼ are deleted.

However, when i=1, in order to prevent two pi number vectors pᵢ (=p₁) including the objective variable from existing, the pi number transformation matrix P of the (2) is not generated.

In addition, as a new candidate P_{new}, a pi number transformation matrix P is generated in which a new pi number transformation vector p_{new} generated by the second generation method is added to the candidate Pₙ, and the pi number transformation vector p₁ is deleted.

Next, in step S805, it is determined whether or not all combinations at the time of selecting one or two pi number transformation vectors from a plurality of pi number transformation vectors included in the pi number transformation matrix Pₙ have been performed. Then, if it is determined as “Yes” in step S805, the process proceeds to step S806, and if it is determined as “No”, the process returns to step S802.

Next, in step S806, the validity of each candidate P_{new} is evaluated by performing the pi number validity evaluation processing S7 using each of the newly generated candidates P_{new} and the physical quantity data set Q as inputs.

Next, in step S807, it is determined whether to adopt the new candidate P_{new} based on the evaluation result obtained by evaluating the validity of each candidate P_{new} in the pi number validity evaluation processing S7. The evaluation result of the validity is obtained by being evaluated by at least one of the similarity transformation validity vₜᵣₐₙₛ by the similarity transformation validity evaluation processing S71 and the relational expression existence v_{reg} by the relational expression existence evaluation processing S72. In the present embodiment, whether to adopt a new candidate P_{new} is determined for both the evaluation results based on the determination expressions shown in the following [Formula 40] and [Formula 41] inequalities. In [Formula 40] inequality, it is determined whether the similarity transformation validity vₜᵣₐₙₛ is equal to or greater than a predetermined threshold value Tₜᵣₐₙₛ. In [Formula 41] inequality, it is determined whether the relational expression existence v_{reg} is equal to or larger than a value obtained by multiplying the relational expression existence v_{reg}, before (initial value when n=0) for the candidate Pₙ searched immediately before by a predetermined threshold value T_{reg}.

$${T}_{trans} \leq {v}_{trans} \qquad [ Formula 40 ]$$

$${v}_{reg , before} {T}_{reg} \leq {v}_{reg} \qquad [ Formula 41 ]$$

As a specific determination method, for example, when the similarity transformation validity vₜᵣₐₙₛ is preferentially adopted, it is determined whether [Formula 40] inequality is satisfied in descending order of the similarity transformation validity vₜᵣₐₙₛ, and when [Formula 40] inequality is satisfied and [Formula 41] inequality is satisfied, it is determined that the new candidate P_{new} is adopted. In addition, when the relational expression existence v_{reg} is preferentially adopted, for example, for the new candidate P_{new} generated by the above (3) of the first generation method, it is determined whether [Formula 41] inequality is satisfied in descending order of the relational expression existence v_{reg}, and further, when [Formula 41] inequality is satisfied and [Formula 40] inequality is satisfied, it is determined that the new candidate P_{new} is adopted. As a result, if it is determined as “Yes” in step S807, the process proceeds to step S808, and if it is determined as “No”, the process returns to step S802.

Next, in step S808, as the evaluation result of the validity of each candidate P_{new}, a new candidate P_{new} evaluated to have the highest validity is substituted into the next candidate Pₙ₊₁ to be processed.

Next, in step S809, it is determined whether to end the search for the new candidate P_{new}. For example, when, as the pi number transformation vector included in the candidate Pₙ₊₁, there is nothing representing the pi numbers of the physical quantities alone, or when the temporary variable n exceeds a predetermined upper limit number of times, it is determined that the search is ended. Then, if it is determined as “Yes” in step S809, a series of pi number search processing S8 is ended, and if it is determined as “No”, the temporary variable n is incremented in step S810, and the process returns to step S802.

In addition, in step S811, it is determined whether the search is performed after tracing back the history searched in the past. For example, when evaluation results of validity continuously decrease in a search loop of a specified number of times in the past, it is determined that the search is performed after tracing back the history.

Then, if it is determined as “Yes” in step S811, the new candidate P_{new} is returned to the candidate Pₙ immediately before the evaluation result of validity continuously decreases in step S812, and the process returns to step S802. This suppresses falling into a local optimal solution. On the other hand, if it is determined as “No” in step S811, it is determined whether to mitigate the search condition in step S813. If it is determined as “Yes” in step S813, the conditions (for example, the threshold values Tₜᵣₐₙₛ and T_{reg}) are mitigated in step S814, and the process returns to step S802. If it is determined as “No”, a series of the pi number search processing S8 is ended.

As described above, in the pi number search processing S8 shown in FIG. 22, a new candidate P_{new} is generated from the candidate Pc for the pi number transformation matrix P by the new candidate generation processing S81, and the validity of the new candidate P_{new} is evaluated from the physical quantity data set Q by the pi number validity evaluation processing S7, so that a more appropriate pi number transformation matrix P_{best} is searched as the pi number transformation matrix P representing the phenomenon in which the physical quantity data set Q is observed. Since any pi number transformation matrix P may be used as the candidate Pc in the initial stage, it is possible to search the pi number transformation matrix P_{best} corresponding to the physical quantity data set Q even with a phenomenon in which the data analyst needs a large amount of effort and deep knowledge merely by deriving the differential equation or a phenomenon in which the differential equation is not originally guessed as long as the physical quantity data set Q is provided.

### Other Embodiments

The present invention is not limited to the above-described embodiments, and various modifications can be made and implemented without departing from the gist of the present invention. Then, these are all included in the technical idea of the present invention.

In the above embodiments, the physical phenomenon according to the physical law has been described as an example of the predetermined phenomenon, but each piece of processing S1 to S8 by the data analysis method 100 is also applicable to a predetermined phenomenon other than the physical phenomenon. In that case, by reading the term “physical quantities” in the above embodiments as “variable quantities” observed in a predetermined phenomenon, the definition of data used in the data analysis method 100 and the processing contents of each piece of processing S1 to S8 can be applied.

In the above embodiments, the phenomenon prediction processing S6 has been described as being performed on the explanatory variable data vector xₒᵤₜ of physical quantities to be predicted in a state where the objective variable data yₒᵤₜ of physical quantities is unknown. On the other hand, even when the objective variable data y of physical quantities is in a known state, the known objective variable data y of physical quantities is assumed to be in an unknown state, and the phenomenon prediction processing S6 is performed on the explanatory variable data vector x of physical quantities having the unknown (originally known is assumed to be unknown) objective variable data y of physical quantities as a pair, whereby the phenomenon prediction processing S6 may predict the objective variable data y′ of physical quantities unknown to the explanatory variable data vector x of physical quantities (originally known is assumed to be unknown).

As described above, the phenomenon prediction processing S6 performed assuming that the known objective variable is in an unknown state can be used in, for example, the similarity transformation validity evaluation processing S71 for evaluating similarity transformation validity. Specifically, the physical quantity data vector q included in the physical quantity data set Q is a pair of the known explanatory variable data vector x of physical quantities and the known objective variable data y of physical quantities, but the known objective variable data y of physical quantities is assumed to be in an unknown state, and the phenomenon prediction processing S6 is performed using the pi number transformation matrix Pₑᵥₐₗ to be processed, the physical quantity data set Q, and the known explanatory variable data vector x of physical quantities as inputs, thereby predicting the unknown (originally known is assumed to be unknown) objective variable data y′ of physical quantities. Then, based on the objective variable data y′ of variable quantities that is the predicted value by the phenomenon prediction processing S6 and the known objective variable data y of physical quantities, for example, determination coefficients and the like of both can be obtained, whereby the similarity transformation validity vₜᵣₐₙₛ can be evaluated.

### EXPLANATION OF REFERENCES

1 data analysis device
10 controller
11 storage
12 input unit
13 output unit
14 communication unit
100 data analysis method
101 prediction function
102 validity evaluation function
103 automatic generation function
110 data analysis program
200 computer

1. A data analysis method for analyzing data on a predetermined phenomenon using a computer, the data analysis method comprising:
performing an inverse transformation on a pi number data vector to obtain a variable quantity data vector based on pi number transformation information;
the pi number transformation information determining, by an exponent of variable quantities included in pi numbers, a relationship between a variable quantity set comprising a plurality of variable quantities observed in the phenomenon and a pi number set comprising one or a plurality of pi numbers configured to be transformed from the variable quantities;
the pi number data vector comprising pi number data that is numerical data of the pi numbers;
the variable quantity data vector comprising variable quantity data that is numerical data of the variable quantities;
the performing of the inverse transformation including:
performing a numerical analysis in which a range of the numerical data in the variable quantity data vector is set to a particular variable quantity region; and
performing pi number inverse transformation processing which inversely transforms the pi number data vector into the variable quantity data vector existing in the variable quantity region.

2. The data analysis method according to claim 1, further comprising:
pi number transformation processing of transforming the variable quantity data vector into the pi number data vector based on the pi number transformation information;
the pi number inverse transformation processing of inversely transforming the pi number data vector after transformation transformed by the pi number transformation processing into the variable quantity data vector existing in the variable quantity region; and
performing pi number transformation/inverse transformation processing of obtaining the variable quantity data vector similar to the variable quantity data vector.

3. The data analysis method according to claim 2, further comprising:
allowing the pi number transformation information to be processed to be input, allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired, and the explanatory variable data vector of variable quantities to be processed to be input; and
using an interpolation range of a set of the explanatory variable data vectors of variable quantities included in the variable quantity data set as the variable quantity region, performing explanatory variable pi number transformation/inverse transformation processing of obtaining the explanatory variable data vector of variable quantities similar to the explanatory variable data vector of variable quantities to be processed by performing the pi number transformation/inverse transformation processing using the pi number transformation information to be processed and the variable quantity region on the explanatory variable data vector of variable quantities to be processed.

4. The data analysis method according to claim 3, further comprising:
allowing the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired, and the explanatory variable data vector of variable quantities to be predicted to be input; and
performing phenomenon prediction processing of predicting the objective variable data of variable quantities unknown to the explanatory variable data vector of variable quantities to be predicted;
wherein the phenomenon prediction processing includes:
obtaining the explanatory variable data vector of variable quantities similar to the explanatory variable data vector of variable quantities to be predicted by performing the explanatory variable pi number transformation/inverse transformation processing using the pi number transformation information to be processed, the variable quantity data set, and the explanatory variable data vector of variable quantities to be predicted as inputs;
obtaining the objective variable data of variable quantities by model prediction from the similar explanatory variable data vector of variable quantities using a prediction model created from the variable quantity data set; and
obtaining the unknown objective variable data of variable quantities based on the pi number data vector after transformation transformed by performing the pi number transformation processing using the pi number transformation information to be processed on objective variable data of variable quantities by the model prediction.

5. The data analysis method according to claim 4, wherein the phenomenon prediction processing includes:
creating the pi number transformation information after transformation by transforming the pi number transformation information to be processed so that an exponent of the objective variable included in the pi numbers becomes 0 except for a particular pi number;
obtaining the similar explanatory variable data vector of variable quantities by performing the explanatory variable pi number transformation/inverse transformation processing with the pi number transformation information after transformation, the variable quantity data set, and the explanatory variable data vector of variable quantities to be predicted as inputs;
creating, based on the variable quantity data set, a prediction model having the explanatory variable set as an input and the objective variable as an output;
obtaining the objective variable data of variable quantities by model prediction by inputting the similar explanatory variable data vector of variable quantities to the prediction model;
by performing the pi number transformation processing with the pi number transformation information after transformation on the variable quantity data vector having a pair of the objective variable data of variable quantities by the model prediction and the similar explanatory variable data vector of variable quantities, obtaining the pi number data vector after transformation; and
by substituting pi number data for the particular pi number in the pi number data vector after transformation and the explanatory variable data vector of variable quantities to be predicted into a definition formula of the particular pi number, obtaining the unknown objective variable data of variable quantities.

6. The data analysis method according to claim 2, further comprising:
allowing the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired to be input; and
by performing the pi number transformation/inverse transformation processing using the pi number transformation information to be processed and the variable quantity region on the variable quantity data vector included in the variable quantity data set with an interpolation range of a set of the explanatory variable data vectors of variable quantities included in the variable quantity data set as the variable quantity region, performing self-space pi number transformation/inverse transformation processing of obtaining the similar variable quantity data vector on the variable quantity data vector.

7. The data analysis method according to claim 6, wherein the self-space pi number transformation/inverse transformation processing includes with a limited region limited to a range narrower than the interpolation range as the variable quantity region, by performing the pi number transformation/inverse transformation processing using the pi number transformation information to be processed and the variable quantity region on the variable quantity data vector included in the variable quantity data set, obtaining the variable quantity data vector similar to the variable quantity data vector.

8. The data analysis method according to claim 7, further comprising:
allowing the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired to be input; and
performing pi number validity evaluation processing of evaluating validity of the pi number transformation information to be processed,
wherein the pi number validity evaluation processing includes:
based on the similar variable quantity data set obtained by performing the self-space pi number transformation/inverse transformation processing using the pi number transformation information to be processed and the variable quantity data set as inputs, performing similarity transformation validity evaluation processing of evaluating similarity transformation validity of the pi number transformation information to be processed; and
evaluating the validity based on an evaluation result of the similarity transformation validity by the similarity transformation validity evaluation processing; and
the similarity transformation validity evaluation processing includes:
creating, based on the variable quantity data set, a prediction model having the explanatory variable data vector of variable quantities as an input and the objective variable data of variable quantities as an output;
obtaining a set of objective variable data of variable quantities by model prediction as a set of the objective variable data of variable quantities by inputting an explanatory variable data set, which is a set of the explanatory variable data vectors of variable quantities included in the similar variable quantity data set, to the prediction model; and
evaluating the similarity transformation validity based on the set of objective variable data of variable quantities, which is a set of the objective variable data of variable quantities included in the similar variable quantity data set, and a set of objective variable data of variable quantities by the model prediction.

9. The data analysis method according to claim 8, wherein
the pi number validity evaluation processing includes:
performing relational expression existence evaluation processing of evaluating relational expression existence of the pi number transformation information to be processed; and
evaluating the validity based on an evaluation result of the similarity transformation validity by the similarity transformation validity evaluation processing and an evaluation result of the relational expression existence by the relational expression existence evaluation processing; and
the relational expression existence evaluation processing includes:
generating the pi number transformation information after transformation by transforming the pi number transformation information to be processed so that an exponent of the objective variable included in the pi number becomes 0 except for a particular pi number;
obtaining a pi number data set including the pi number data vector after transformation by performing the pi number transformation processing using the pi number transformation information after transformation on each of the variable quantity data vectors included in the variable quantity data set;
dividing the pi number data set into a pi number data set for training and a pi number data set for testing;
creating a prediction model having another pi number other than the particular pi number as an input and the particular pi number as an output based on the pi number data set for training;
obtaining an objective variable data set of pi numbers by model prediction as a set of the pi number data for the particular pi number by inputting an explanatory variable data set of pi numbers, which is a set of the pi number data for the other pi number included in the pi number data set for testing, to the prediction model; and
evaluating the relational expression existence based on an objective variable data set of pi numbers that is a set of the pi number data for the particular pi number included in the pi number data set for testing and an objective variable data set of pi numbers by the model prediction.

10. The data analysis method according to claim 9, further comprising:
allowing a candidate for the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired to be input; and
performing pi number search processing of searching for the pi number transformation information satisfying a predetermined condition by repeatedly performing new candidate generation processing of generating a new candidate from the candidate and the pi number validity evaluation processing using the new candidate generated by the new candidate generation processing and the variable quantity data set as inputs.

11. The data analysis method according to claim 10, wherein the new candidate generation processing includes:
selecting one or two of the pi number transformation vectors from a plurality of pi number transformation vectors included in the candidate;
generating the new pi number transformation vector based on a combination of weighted sums of the one or two pi number transformation vectors; and
generating the new candidate by adding the new pi number transformation vector to the candidate.

12. A data analysis device comprising a computer including a controller configured to execute each piece of processing performed by the data analysis method according to claim 1.

13. A non-transitory computer-readable recording medium storing thereon a data analysis program for causing a computer to execute each piece of processing performed by the data analysis method according to claim 1.

14. The data analysis method according to claim 8, further comprising:
allowing a candidate for the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired to be input; and
performing pi number search processing of searching for the pi number transformation information satisfying a predetermined condition by repeatedly performing new candidate generation processing of generating a new candidate from the candidate and the pi number validity evaluation processing using the new candidate generated by the new candidate generation processing and the variable quantity data set as inputs.

15. The data analysis method according to claim 14, wherein the new candidate generation processing includes:
selecting one or two of the pi number transformation vectors from a plurality of pi number transformation vectors included in the candidate;
generating the new pi number transformation vector based on a combination of weighted sums of the one or two pi number transformation vectors; and
generating the new candidate by adding the new pi number transformation vector to the candidate.

16. The data analysis method according to claim 6, further comprising:
allowing the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired to be input; and
performing pi number validity evaluation processing of evaluating validity of the pi number transformation information to be processed,
wherein the pi number validity evaluation processing includes:
based on the similar variable quantity data set obtained by performing the self-space pi number transformation/inverse transformation processing using the pi number transformation information to be processed and the variable quantity data set as inputs, performing similarity transformation validity evaluation processing of evaluating similarity transformation validity of the pi number transformation information to be processed; and
evaluating the validity based on an evaluation result of the similarity transformation validity by the similarity transformation validity evaluation processing, and
the similarity transformation validity evaluation processing includes:
creating, based on the variable quantity data set, a prediction model having the explanatory variable data vector of variable quantities as an input and the objective variable data of variable quantities as an output;
obtaining a set of objective variable data of variable quantities by model prediction as a set of the objective variable data of variable quantities by inputting an explanatory variable data set, which is a set of the explanatory variable data vectors of variable quantities included in the similar variable quantity data set, to the prediction model; and
evaluating the similarity transformation validity based on the set of objective variable data of variable quantities, which is a set of the objective variable data of variable quantities included in the similar variable quantity data set, and a set of objective variable data of variable quantities by the model prediction.

17. The data analysis method according to claim 16, wherein
the pi number validity evaluation processing includes:
performing relational expression existence evaluation processing of evaluating relational expression existence of the pi number transformation information to be processed; and
evaluating the validity based on an evaluation result of the similarity transformation validity by the similarity transformation validity evaluation processing and an evaluation result of the relational expression existence by the relational expression existence evaluation processing, and
the relational expression existence evaluation processing includes:
generating the pi number transformation information after transformation by transforming the pi number transformation information to be processed so that an exponent of the objective variable included in the pi number becomes 0 except for a particular pi number;
obtaining a pi number data set including the pi number data vector after transformation by performing the pi number transformation processing using the pi number transformation information after transformation on each of the variable quantity data vectors included in the variable quantity data set;
dividing the pi number data set into a pi number data set for training and a pi number data set for testing;
creating a prediction model having another pi number other than the particular pi number as an input and the particular pi number as an output based on the pi number data set for training;
obtaining an objective variable data set of pi numbers by model prediction as a set of the pi number data for the particular pi number by inputting an explanatory variable data set of pi numbers, which is a set of the pi number data for the other pi number included in the pi number data set for testing, to the prediction model; and
evaluating the relational expression existence based on an objective variable data set of pi numbers that is a set of the pi number data for the particular pi number included in the pi number data set for testing and an objective variable data set of pi numbers by the model prediction.

18. The data analysis method according to claim 17, further comprising:
allowing a candidate for the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired to be input; and
performing pi number search processing of searching for the pi number transformation information satisfying a predetermined condition by repeatedly performing new candidate generation processing of generating a new candidate from the candidate and the pi number validity evaluation processing using the new candidate generated by the new candidate generation processing and the variable quantity data set as inputs.

19. The data analysis method according to claim 18, wherein the new candidate generation processing includes:
selecting one or two of the pi number transformation vectors from a plurality of pi number transformation vectors included in the candidate;
generating the new pi number transformation vector based on a combination of weighted sums of the one or two pi number transformation vectors; and
generating the new candidate by adding the new pi number transformation vector to the candidate.

20. The data analysis method according to claim 16, further comprising:
allowing a candidate for the pi number transformation information to be processed to be input;
allowing a variable quantity data set that is a set of the variable quantity data vectors in which a plurality of the variable quantities are classified into an objective variable and an explanatory variable set including one or a plurality of explanatory variables, and objective variable data of variable quantities that is numerical data of the objective variable and an explanatory variable data vector of variable quantities including explanatory variable data that is numerical data of the explanatory variable are paired to be input; and
performing pi number search processing of searching for the pi number transformation information satisfying a predetermined condition by repeatedly performing new candidate generation processing of generating a new candidate from the candidate and the pi number validity evaluation processing using the new candidate generated by the new candidate generation processing and the variable quantity data set as inputs.

21. The data analysis method according to claim 20, wherein the new candidate generation processing includes:
selecting one or two of the pi number transformation vectors from a plurality of pi number transformation vectors included in the candidate;
generating the new pi number transformation vector based on a combination of weighted sums of the one or two pi number transformation vectors; and
generating the new candidate by adding the new pi number transformation vector to the candidate.
